(19) United States
(12) Patent Application Publication
(10) Pub. No.: US 2026/0281658 A1
(43) Pub. Date: Sep. 17, 2026

(54) TRANSMITTING A REQUEST FOR ASSISTANCE INFORMATION

(71) Applicant: Lenovo (Singapore) Pte. Ltd., Singapore (SG)

(72) Inventors: Seyedomid Taghizadeh Motlagh, Oberursel (DE); Genadi Velev, Darmstadt (DE); Robin Rajan Thomas, Bad Nauheim (DE); Ali Ramadan Ali, Kraiburg am Inn (DE)

(21) Appl. No.: 19/157,140

(22) PCT Filed: Feb. 17, 2024
(86) PCT No.: PCT/IB2024/051531

§ 371 Date: Aug. 15, 2025

Related U.S. Application Data
(60) Provisional application No. 63/446,775, filed on Feb. 17, 2023.

(51) Int. Cl. H04W 4/021; H04W 4/38

(52) U.S. Cl. CPC H04W 4/021; H04W 4/38

(57) ABSTRACT

Apparatuses, methods, and systems are disclosed for requesting assistance information in association with a sensing request. One method (1600) includes receiving (1602), from a sensing services client, Sensing a request for sensing information. In certain embodiments, the method (1600 ) includes transmitting (1604), to a location management entity, a request for assistance information of one or more devices associated with an area of interest. In certain embodiments, the method (1600) includes receiving (1606), from the location management entity, a response to the request for the assistance information. In certain embodiments, the method (1600) includes calculating (1608) the sensing information based at least in part on received assistance information.

### FIELD

The subject matter disclosed herein relates generally to wireless communications and more particularly relates to requesting assistance information for one or more devices associated with an area of interest, e.g., in response to a request for sensing services.

### BACKGROUND

In certain wireless communications networks, radio sensing may be used to obtain environment information. Generally, a radio sensing operation comprise the transmission of a sensing signal and reception of reflections (e.g., echoes) of the transmitted sensing signal.

### BRIEF SUMMARY

Methods for requesting assistance information in association with a sensing request are disclosed. One embodiment of a method includes receiving, from a sensing services client, a request for sensing information. In certain embodiments, the method includes transmitting, to a location management entity, a request for assistance information of one or more devices associated with an area of interest. In certain embodiments, the method includes receiving, from the location management entity, a response to the request for the assistance information. In certain embodiments, the method includes calculating the sensing information based at least in part on received assistance information.

One apparatus for requesting assistance information in association with a sensing request may include a sensing management entity. In some embodiments, the apparatus includes a processor and a memory coupled to the processor, the memory comprising instructions executable by the processor to cause the apparatus to receive, from a sensing services client, a request for sensing information. In certain embodiments, the instructions are further executable by the processor to cause the apparatus to transmit, to a location management entity, a request for assistance information of one or more devices associated with an area of interest and to receive, from the location management entity, a response to the request for the assistance information. In certain embodiments, the instructions are further executable by the processor to cause the apparatus to determine the sensing information based at least in part on received assistance information.

Another embodiment of a method for requesting assistance information in association with a sensing request includes receiving, from a sensing management entity, a request for assistance information of one or more devices associated with an area of interest. In certain embodiments, the method includes calculating the assistance information associated with the area of interest. In certain embodiments, the method includes transmitting, to the sensing management entity, a response to the request for the assistance information.

Another apparatus for requesting assistance information in association with a sensing request may include a location management entity. In some embodiments, the apparatus includes a processor and a memory coupled to the processor, the memory comprising instructions executable by the processor to cause the apparatus to receive, from a sensing management entity, a request for assistance information (e.g., presence and/or positioning information) of one or more devices associated with an area of interest (e.g., according to indicated permissibility criteria). In certain embodiments, the instructions are further executable by the processor to cause the apparatus to determine the assistance information associated with the area of interest and to transmit, to the sensing management entity, a response to the request for the assistance information.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for requesting assistance information in association with a sensing request;

FIG. 2 is a schematic block diagram illustrating one embodiment of an apparatus that may be used for requesting assistance information in association with a sensing request;

FIG. 3 is a schematic block diagram illustrating one embodiment of an apparatus that may be used for requesting assistance information in association with a sensing request;

FIG. 4A is a schematic block diagram illustrating embodiments of sensing scenarios with a network as a sensing transmitter (“Tx”);

FIG. 4B is a schematic block diagram illustrating embodiments of sensing scenarios with a user equipment (“UE”) as a sensing Tx;

FIG. 5 is a schematic block diagram illustrating one embodiment of a system having an integrated sensing and positioning framework;

FIG. 6 is a schematic block diagram illustrating one embodiment of a system having a sensing assisted positioning framework;

FIG. 7 is a schematic block diagram illustrating embodiments of a systems having different sensing and/or location management function (“SLMF”) configurations;

FIG. 8 is a schematic block diagram illustrating embodiments of timing diagrams having different measurement configurations with intermediate reporting and/or an assistance information update;

FIG. 9 is a schematic block diagram illustrating one embodiment of communications for joint sensing and positioning measurements;

FIG. 10 is a schematic block diagram illustrating embodiments of reference signal (“RS”) time-domain muting and/or transmission and sensing according to anchor node (“AN”) capabilities;

FIG. 11 is a schematic block diagram illustrating embodiments of RS frequency-domain configurations including muting and power boosting for joint positioning and sensing measurements;

FIG. 12 is a schematic block diagram illustrating one embodiment of communications for sensing-based UE position verification;

FIG. 13 is a schematic block diagram illustrating one embodiment of communications for radar cross section (“RCS”) information acquisition relevant to a target UE;

FIG. 14 is a schematic block diagram illustrating one embodiment of communications for location management function (“LMF”)-triggered sensing (e.g., sensing-assisted positioning) in which an LMF requests sensing function (“SF”) for sensing information;

FIG. 15 is a schematic block diagram illustrating one embodiment of communications for an LMF-assisted sensing procedure in which an SF requests UE presence and/or positioning information from an LMF;

FIG. 16 is a flow chart diagram illustrating one embodiment of a method for requesting assistance information in association with a sensing request; and

FIG. 17 is a flow chart diagram illustrating another embodiment of a method for requesting assistance information in association with a sensing request.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

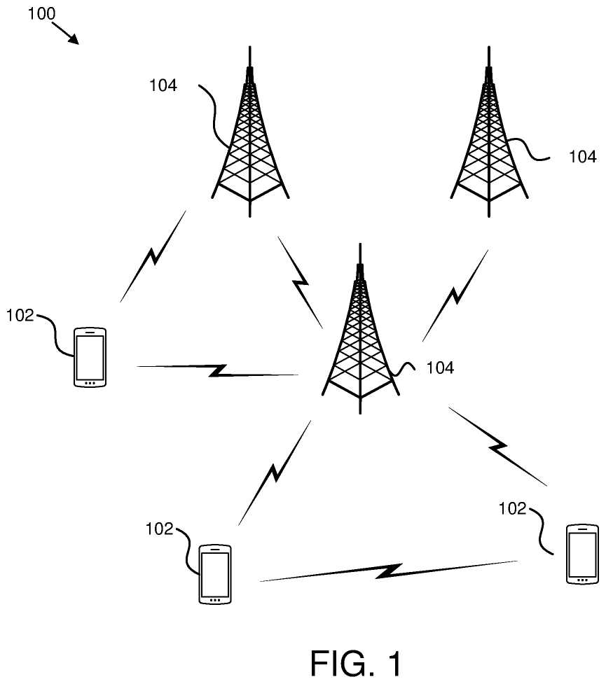

FIG. 1 depicts an embodiment of a wireless communication system 100 for requesting assistance information in association with a sensing request. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via uplink (“UL”) communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-third generation partnership project (“3GPP”) gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in 3GPP, wherein the network unit 104 transmits using an orthogonal frequency division multiplexing (“OFDM”) modulation scheme on the downlink (“DL”) and the remote units 102 transmit on the UL using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 and/or a network unit 104 may receive, from a sensing services client, a request for sensing information and transmit, to a location management entity, a request for assistance information of one or more devices associated with an area of interest. In certain embodiments the remote unit 102 and/or a network unit 104 may further receive, from the location management entity, a response to the request for the assistance information and determine the sensing information based at least in part on received assistance information.

In other embodiments, a remote unit 102 and/or network unit 104 may receive, from a sensing management entity, a request for assistance information of one or more devices associated with an area of interest. In certain embodiments, the remote unit 102 and/or network unit 104 may determine the assistance information associated with the area of interest and transmit, to the sensing management entity, a response to the request for the assistance information.

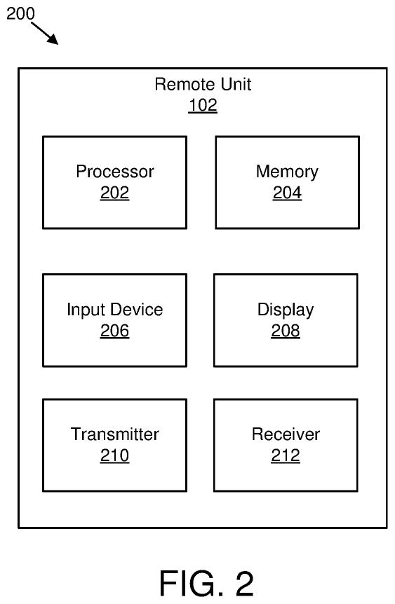

FIG. 2 depicts one embodiment of an apparatus 200 that may be used for requesting assistance information in association with a sensing request. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In some embodiments, the receiver 212 may receive, from a sensing services client, a request for sensing information and the transmitter 210 may transmit, to a location management entity, a request for assistance information of one or more devices associated with an area of interest. In certain embodiments, the receiver 212 may further receive, from the location management entity, a response to the request for the assistance information and the processor 202 may determine the sensing information based at least in part on received assistance information.

In some embodiments, the receiver 212 may receive, from a sensing management entity, a request for assistance information of one or more devices associated with an area of interest. In certain embodiments, the processor 202 may determine the assistance information associated with the area of interest and the transmitter 210 may transmit, to the sensing management entity, a response to the request for the assistance information.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

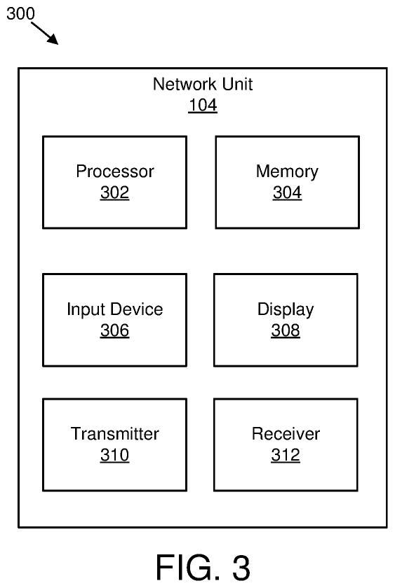

FIG. 3 depicts one embodiment of an apparatus 300 that may be used for requesting assistance information in association with a sensing request. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In some embodiments, the receiver 312 may receive, from a sensing services client, a request for sensing information and the transmitter 310 may transmit, to a location management entity, a request for assistance information of one or more devices associated with an area of interest. In certain embodiments, the receiver 312 may further receive, from the location management entity, a response to the request for the assistance information and the processor 302 may determine the sensing information based at least in part on received assistance information.

In some embodiments, the receiver 312 may receive, from a sensing management entity, a request for assistance information of one or more devices associated with an area of interest. In certain embodiments, the processor 302 may determine the assistance information associated with the area of interest and the transmitter 310 may transmit, to the sensing management entity, a response to the request for the assistance information.

It should be noted that one or more embodiments described herein may be combined into a single embodiment.

In various wireless networks, such as in cellular wireless networks, radio sensing may be used as a mechanism to improve network performance and as an enabler to serve vertical use systems. In certain embodiments, radio sensing may obtain environment information by one or more of the following: 1) transmission of a sensing signal (e.g., a sensing RS from a network or UE entity-referred to by the term “sensing Tx node”; 2) reception of reflections and/or echoes of a transmitted sensing excitation signal from an environment by a network or a UE entity-referred to by the term “sensing Rx node”; and/or 3) processing the received reflections and inferring relevant information from the environment.

It should be noted that this disclosure is not limited to joint positioning and sensing operation scenarios and any realization of sensing or positioning as inferred from the embodiments is valid as a stand-along scenario (e.g., a sensing scenario or a positioning scenario) as well.

In some embodiments, by viewing a UE (and/or surroundings and/or attachments of a target UE) as a physical object, sensing measurements of the UE and a positioning measurement of the UE may be jointly and/or interchangeably re-used and/or optimized. Such embodiments may enable an integrated positioning and sensing framework, wherein: 1) the sensing and positioning information of a target UE are jointly obtained and/or optimized (e.g., via a joint measurement configuration); 2) the obtained positioning information of the UE (e.g., as a physical object) may enable augmentation and/or enhancement of the sensing measurements within an area of interest for sensing; and/or 3) the obtained sensing information and/or measurements of the UE may be utilized to augment and/or enhance the positioning measurements of the target UE. As used herein, the term “positioning information” refers to information indicating a geo-spatial location, e.g., of a target device. Examples of positioning information include, but are not limited to, a spatial position of the target device, a velocity of the target device, a speed of the target device, a heading of the target device, an orientation of the target device, or the like. Examples of a target device include, but are not limited to, a UE device, a radio access network (“RAN”) node, a network controlled repeater (“NCR”) device, a reconfigurable intelligent surface (“RIS”), an integrated access and backhaul (“IAB”) node, or the like.

In various embodiments, it may be determined how radio configurations (e.g., including RS transmission, measurements, and computation of desired information) of a radio sensing operation and a target UE positioning operation may be jointly configured within the context of a RAN (e.g., RAN and/or radio configuration of joint radio sensing and positioning measurements).

In certain embodiments, it may be determined how known physical characteristics of a target UE are obtained (e.g., as known assisting information) and used by a network in the context of a joint sensing and positioning operation (e.g., obtaining a physical description of the target UE from an application or RAN).

In some embodiments, upon reception of a positioning information request of a target UE from a location service (“LCS”) client by a LMF, the LMF may obtain sensing information of the target UE in the context of positioning of the target UE (e.g., via a core network (“CN”) to CN interface, LMF obtaining sensing information).

In various embodiments, a sensing management entity may obtain positioning information of UEs as physical objects present in an area of interest in the context of a radio sensing operation of an area of interest (e.g., via a CN to CN interface, via obtaining presence and/or location information of the UEs).

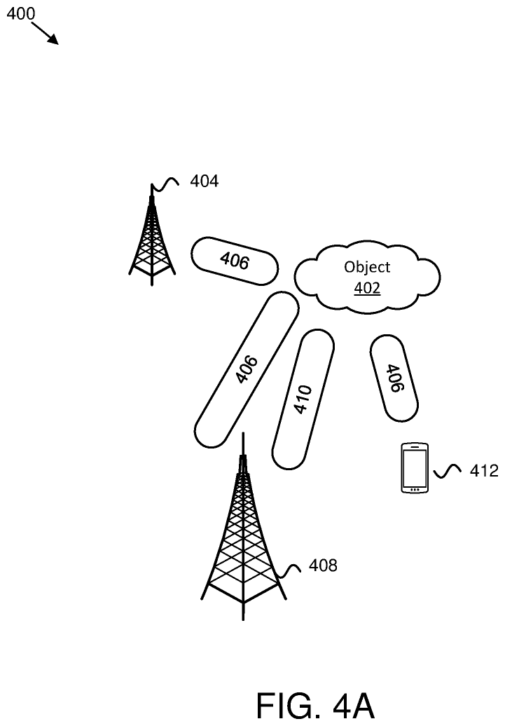

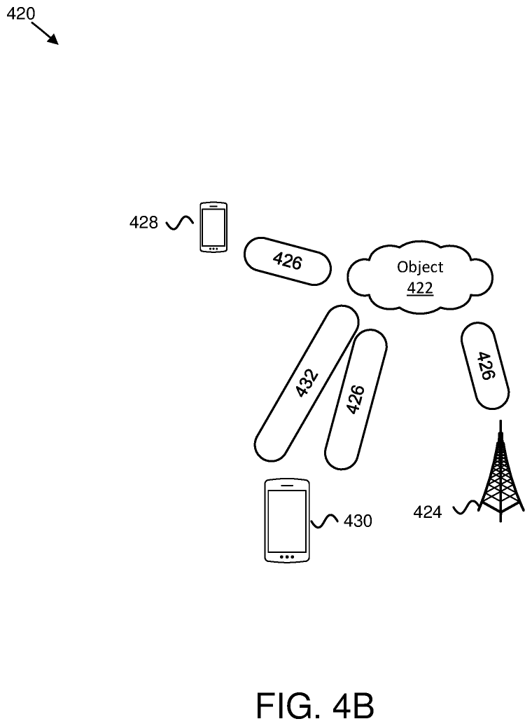

In certain embodiments, a functional split between a network and UE nodes for a specific sensing task may take various forms depending on the availability of sensing-capable devices and the requirements of the specific sensing operation as shown in FIG. 4A and FIG. 4B.

FIG. 4A is a schematic block diagram 400 illustrating embodiments of sensing scenarios with a network as a sensing Tx. The schematic block diagram 400 includes an object 402 and a first gNB 404 operating as a sensing Rx that receives a sensing signal Rx 406. The schematic block diagram 400 further includes a second gNB 408 operating as a sensing Rx and a sensing Tx that transmits a sensing signal Tx 410, and a UE 412. Cases I, II, and III correspond to the schematic block diagram 400.

FIG. 4B is a schematic block diagram 420 illustrating embodiments of sensing scenarios with a UE as a sensing Tx. The schematic block diagram 420 includes an object 422 and a gNB 424 operating as a sensing Rx that receives a sensing signal Rx 426. The schematic block diagram 420 further includes a first UE 428 operating as a sensing Rx, and a second UE 430 operating as a sensing Rx and a sensing Tx that transmits a sensing signal Tx 432. Cases IV, V, and VI correspond to the schematic block diagram 420.

In a first configuration (e.g., Case I), a sensing Tx may be a network node and a sensing Rx may be a separate network node. In this configuration, the sensing RS (or another RS used for sensing or the data and/or control channels known to the network transmission and reception point (“TRP”) nodes) is transmitted and received by network entities. The involvement of UE nodes may be limited to interference management. The network does not use UEs for sensing assistance in this configuration.

In a second configuration (e.g., Case II), the sensing Tx may be a network node and the sensing Rx may be the same network node. In this configuration, the sensing RS (or another RS used for sensing or the data and/or control channels known to the network TRP nodes) is transmitted and received by the same network entity. The involvement of UE nodes may be limited to interference management. The network does not use UEs for sensing assistance in this configuration.

In a third configuration (e.g., Case III), the sensing Tx may be a network node and the sensing Rx may be a UE node. In this configuration, the sensing RS or other RS used for sensing is transmitted by a network entity and received by one or more UE nodes. The network configures the UEs to act as sensing Rx nodes based on the UE node capabilities for sensing and a desired sensing task.

In a fourth configuration (e.g., Case IV), the sensing Tx may be a UE node and the sensing Rx may be a network node. In this configuration, the sensing RS or other RS used for sensing (or a data and/or control channel transmitted by the UE) is received by one or more network entities and transmitted by a UE node. The network configures the UE to act as a sensing Tx node based on the UE node capabilities for sensing and a nature of the desired sensing task.

In a fifth configuration (e.g., Case V), the sensing Tx may be a UE node and the sensing Rx may be a separate UE node. In this configuration, the sensing RS or other RS used for sensing is received by one or more UE nodes and transmitted by a UE node. Moreover, the network or a UE node may decide on a configuration of the sensing scenario. In one embodiment, the network configures UEs to act as sensing Tx and/or sensing Rx nodes based on the UE node capabilities for sensing and a nature of the desired sensing task.

In a sixth configuration (e.g., Case VI), the sensing Tx may be a UE node and the sensing Rx may be the same UE node. In this configuration, the sensing RS (or another RS used for sensing or the data and/or control channels known to the UE) is transmitted by a UE node and received by the same UE node. Moreover, the UE or the network configures the sensing scenario based on the UE node capabilities for sensing and the nature of the desired sensing task.

It should be noted that the first through sixth configuration are not intended to be restricted to a specific UE type and may include any UE category and/or functionality (e.g., a UE roadside unit (“RSU”)). Moreover, the roles depicted for a gNB and/or a UE may be replaced (e.g., with equal validity as an example of a radio sensing scenario) with a smart repeater node, an IAB node, and/or an RSU.

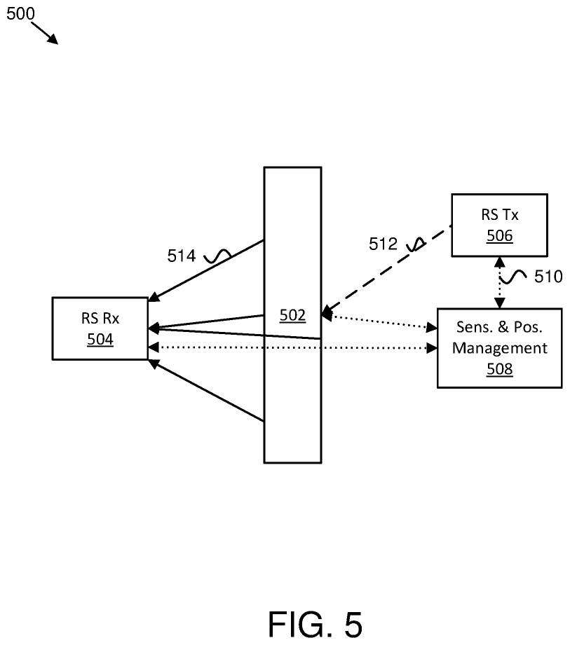

FIG. 5 is a schematic block diagram illustrating one embodiment of a system 500 having an integrated sensing and positioning framework. The UE positioning measurements and the RS Rx radio sensing measurements are combined to obtain UE positioning-related parameters. The system 500 includes a UE 502, a RS Rx 504 (e.g., gNB and/or UE), a RS Tx 506 (e.g., gNB, TRP), and a sensing and position management device 508. Control signals 510, RS transmission 512, and RS reflection and/or refraction 514 are illustrated showing communications between the devices.

In certain embodiments, there may be a RAN and/or radio configuration for joint radio sensing and positioning. In such embodiments, a first AN (e.g., RS Tx) is configured by the network to transmit a RS and a UE is configured to measure the positioning-related parameters (e.g., time of arrival (“ToA”), time of flight (“ToF”), angle of arrival (“AoA”), RS time difference (“RSTD”), receive (“Rx”)-Tx time difference, relative ToA (“RTOA”), RS received power (“RSRP”), reference signal received path power (“RSRPP”) of one or more paths based on RS reception). Moreover, a second AN (e.g., RS Rx) is configured by the network to perform radio sensing measurements (e.g., detection of an object in a pre-defined area, ToA and/or ToF from the paths within an area of interest for sensing, RSRPP and/or AoAs from the area of interest for sensing, measured time differences amongst different pairs of entities) based on an a known potential area of the UE and/or the information of the UE (e.g., UE RCS and/or UE immediate surroundings). The obtained radio sensing measurement from the RS Rx node and the positioning measurements at the UE are collected and jointly processed at one or more network entities to estimate the UE position, orientation, heading, and/or velocity.

In some embodiments, a physical description of a target UE may be obtained from an application or RAN and/or the target UE may be viewed as a physical object. The sensing and positioning measurements may benefit from known physical characteristics of a UE. To accomplish this, the requesting entity for sensing and/or positioning information may indicate the physical characteristics of the target UE and/or RCS related information of the target UE to the sensing and positioning management entity (e.g., autonomously or upon request of the sensing or positioning management entity). The sensing and positioning management entity uses this information for configuration of the sensing measurements and for computation of the positioning information of the target UE.

In various embodiments, an LMF may obtain sensing information and/or measurements. Upon reception of a positioning information request of a target UE from an LCS client by an LMF, the LMF sends a request to a SF (e.g., a core network entity at least partly responsible for receiving the request for a sensing information, obtaining the sensing information, and/or exposing the obtained sensing information to the requesting party) for the desired sensing information of the target UE. The SF then obtains the requested sensing information and/or measurements of the UE and informs the LMF of the obtained information and/or measurements.

In certain embodiments, there may be a CN to CN interface and an SF may obtain presence and/or location information of UEs. Upon reception of a request for sensing information at an area of interest for sensing by an SF (e.g., from a sensing client), the SF requests that the LMF provide presence information of the UEs at an indicated area of interest. The LMF may determine the presence of the UEs based on prior UE positioning information or may request help from next generation (“NG”)-RAN nodes for determining UE presence and/or positioning information at a given area of interest. The obtained UE information (e.g., a list of the present UE identifiers (“IDs”), UE position and/or velocity information, and/or UE RCS information) is provided to the SF.

It should be noted that embodiments herein are not limited to the described implementation elements, and one or more elements from one or more embodiments herein may be combined to construct a new embodiment. Moreover, it should be noted that embodiments herein are not limited to joint positioning and sensing operation scenarios. Any realization of sensing or positioning inferred from the embodiments herein may be valid as stand-alone scenarios (e.g., a sensing scenario, or a positioning scenario).

In a first embodiment, there may be joint radio sensing and positioning measurements. In this embodiment, in the context of a positioning procedure of a target UE, one or more ANs and/or an SLMF may determine a first RS configuration so that the first RS configuration is transmitted from a first AN according to a first transmission configuration, and received by the target UE according to a first positioning reception configuration and by a second AN according to a first sensing reception configuration. The SLMF may be a new entity or functionality incorporated into one or more existing NFs (e.g., LMF that provides radio sensing coordination and management capabilities for a given network). Further, the SLMF may be implemented as a server or an entity with significant computing and processing capabilities. Moreover, the second AN may be configured via a first sensing measurement and reporting configuration for performing sensing measurements and sending a report to the SLMF based on the received first RS and set of associated measurement criteria (e.g., associated measurement metrics). The target UE may be configured via a first positioning measurement and reporting configuration for performing positioning measurements and sending a report to the sensing and/or positioning management entity based on the received first RS. The SLMF estimates the position of the target UE based at least in part on the received positioning measurement report of the target UE and the sensing measurement report of the second AN.

In some embodiments, one or more RS resources are transmitted by one or more ANs (e.g., the one or more ANs are configured for transmission of the corresponding one or more RS resources) and received and processed by at least one target UE (e.g., the at least one target UE is configured for reception of the one or more RS resources and configured to perform positioning measurement and reporting based on the received one or more RSs) and one or more ANs (e.g., each configured for reception of the one or more RS resources and configured to perform sensing measurement and reporting based on the received one or more RSs). Moreover, the position of the at least one target UE node is estimated at the SLMF based at least in part on the received positioning measurement reports of the target UE and the sensing measurement reports of the one or more ANs.

In various embodiments, if an AN is capable of full-duplex transmission and reception over at least part of an RS time-frequency resource, the AN is simultaneously configured to transmit a RS and configured to receive the at least part of the RS and further configured to perform sensing measurement and reporting based on the received at least part of the RS. In certain embodiments, based upon the capability of an AN for Rx measurement, the AN indicates a subset of the RS resources over which it may perform sensing measurements.

In some embodiments, ANs that are configured to transmit one or more RSs and/or the ANs configured to receive the one or more RSs include one or more of: a gNB, a gNB-distributed unit (“DU”), a gNB-centralized unit (“CU”), a TRP, a positioning reference signal (“PRS”)-only TRP, an RSU, a network controlled repeater (“NCR”), an IAB node, and/or a UE. In various embodiments, the RS is a PRS, a channel state information (“CSI”) RS (“CSI-RS”), a sensing-dedicated RS (e.g., sensing RS), primary synchronization signal (“PSS”), secondary synchronization signal (“SSS”), CSI-RS, and/or a demodulation reference signal (“DMRS”).

In some embodiments, configuration parameters defining the RS transmission for the AN configured with the transmission of the RS, configuration parameters defining the RS for the target UE device configured with a positioning measurement and reporting based on at least in part the indicated RS (e.g., where the RS parameters or a subset thereof is indicated to the target UE device), and/or configuration parameters defining the RS for an AN configured with a sensing measurement and reporting based at least in part on the indicated RS (e.g., where the RS parameters or a subset thereof is indicated to the AN) further includes an illumination distance (e.g., from the transmission point), and/or area of illumination (e.g., the area of radio frequency (“RF”) illumination relative to the transmission point or defined according to a global coordinate system). In various embodiments, information of the RF illumination area, illumination area, and/or illumination distance is indicated as part of a configuration information or assisting information for a positioning and/or sensing measurements, or is reported to the SLMF.

In certain embodiments, an RS configuration for transmission from an AN and reception by a UE and/or reception by an AN includes at least one or more of: 1) a waveform type or waveform-defining parameters for the RS signal (e.g., the waveform type if the waveform is different from that of the used waveform for other data and/or control transmission and/or receptions by the same nodes, subcarrier spacing (“SCS”) for the sensing RS signal if there are OFDM-based waveforms or other multi-carrier waveform types, a length and type of redundancy, e.g., cyclic prefix (“CP”)-length if CP-OFDM, or redundancy type and length if unique word (“UW”)-OFDM); 2) one or more Tx antenna ports, transmission beams, transmission radiation patterns, and/or transmission radiation characteristics (e.g., panning angle, beam angle in azimuth, beam angle in elevation and/or zenith, beam width) for the transmission of the RS; 3) one or more Rx antenna port or reception beams for the reception of the RS; 4) RS resources according to the used waveform for RS transmission (e.g., CP-OFDM time and/or frequency resource pattern; 5) the sequence generation and physical resource mapping of the generated sequence; and/or 6) Tx power for the transmission of the RS, time and/or frequency offset with respect to a reference time and/or frequency point, an associated periodicity of the RS, an indication on whether the RS is to be repeated (e.g., defining a set of repetitions, comb-size patterns, number of symbols, carrier configurations, e.g., positioning frequency layer).

In some embodiments, a sensing measurement and reporting configuration and/or positioning measurement and reporting configuration includes a reporting configuration. The reporting configuration includes at least one or more of: 1) a set of time, frequency, and/or beam resources for the transmission of the generated report; 2) a type of the information included in the generated report; and/or 3) one or more criteria for the transmission of the report (e.g., a criterion based on the performed measurements to trigger time-based reporting including aperiodic, periodic, semi-persistent, or event-triggered reporting). Moreover, the reporting configuration may include one or more of: 1) when measurement information, according to a measurement information output type, is available; 2) when a generated measurement information output, according to a measurement information output type or multiple of the generated measurement outputs, satisfy a specific condition (e.g., a measured received RS power is above a threshold); 3) when an object is detected with a reported probability of higher than indicated (e.g., 95%); 4) when a modification of a known object (or group of objects) state (e.g., object state including blocked and/or non-blocked detected to be present and/or not-present) persists over a specific period; and/or 5) when an object is detected with a threshold probability at an indicated sensitive area of monitoring.

In various embodiments, positioning measurement and reporting configuration of a target UE includes one or more indications to measure and/or report the AoA, zenith angle of arrival (“ZoA”), RSRP, RSRPP, doppler shift value, delay, ToF, ToA, RSTD, and/or Rx−Tx time difference corresponding to a propagation path of an RS transmitted by an AN and detected at the target UE, and one or multiple time difference of arrival (“TDoA”) corresponding to a first and/or line of sight (“LOS”) propagation path of a first AN to the target UE and a first and/or LOS propagation path of a second AN to the target UE. In certain embodiments, the one or more measurements may be performed and/or reported on the first arrived path or the detected LOS path at the target UE.

In some embodiments, all obtained measurement values, according to the received positioning measurement and reporting configurations at the target UE or a subset thereof, are reported to the SLMF. In various embodiments, measurement of a propagation path are reported to the SLMF if the detected propagation path complies with some indicated criterion (e.g., when measured RSRPP for a detected path is above an indicated threshold), wherein the threshold is indicated to the target UE by the SLMF, when the measured ToF, delay, and/or ToA is below an indicated threshold by the SLMF, and/or when the propagation path AoA and/or ZoA is within an indicated angular range by the SLMF. In one implementation, the positioning measurements of AoA, ZoA, RSRPP, and doppler shift are configured to be obtained at the target UE and reported to the SLMF if the corresponding RSRPP is above an indicated threshold and the measured ZoA is below an indicated value to the target UE.

In certain embodiments, positioning measurements at a target UE include a position estimate of the target UE, a subset of the position parameters of the target UE (e.g., position estimate along the x-axis of a global coordinate system), and/or the position estimate along the x-axis and y-axis of a global coordinate system. In some embodiments, a positioning measurement and reporting configuration includes an indication of an estimate accuracy of a reported and/or measured parameter (e.g., accuracy of the estimated positioning parameters, the measured RSRP and/or RSRPP) and/or the estimated AoA. In various embodiments, a parameter accuracy includes an indication of a statistical measure (e.g., confidence interval), an estimation mean squared error, and/or a probability of an estimation error below an indicated threshold. In certain embodiments, an estimation accuracy is indicated via an index from a codebook, where the codebook defines different possible estimation accuracies for one or more measurements.

In some embodiments, a target UE transmits a report to an SLMF and/or a serving gNB about available surrounding UEs as candidates to serve as ANs for sensing reception and/or transmission. The target UE may gather this information from surrounding UEs via sidelink (“SL”) (e.g., via a UE to UE (“PC5”) interface) via appropriate request and response signaling. In various embodiments, a report of surrounding UEs of a target UE may include a capability of detected surrounding UEs to serve as sensing receiver and/or transmitter nodes. In certain embodiments, RCS related information about a target UE is transmitted to other candidate UEs in the vicinity (e.g., connected via a PC5 link to the target UE) to act as an AN for sensing measurements.

In various embodiments, a sensing measurement and reporting configuration at a second AN based on an RS transmitted by a first AN includes one or more of: 1) an initial estimate of a target UE position given as an angular range, position range (e.g., two dimensional (“2D”) and/or three dimensional (“3D”)), latitude and/or longitude coordinates, and/or a velocity range, according to a global and/or local coordinate system known to the second AN (e.g., an area of interest for sensing measurements such as a convex combination of 4 indicated positions according to the global coordinate system); 2) RCS information of the target UE (e.g., all or part of the RCS-related information reported by the target UE); 3) relative positioning information of the objects in the UE surroundings (e.g., a known tower with distance of 10 meters to the target UE); 4) RCS-related information of the objects in the UE surroundings (e.g., size and/or RCS of the tower in the vicinity of the UE); 5) RS-defining parameters of the one or more transmitted RSs (e.g., time-frequency resources of the transmitted RS, beam information of the transmitted RS); 6) RS transmission reference point corresponding to an RS (e.g., position of the TRP of the first AN); 7) quasi-co-location (“QCL”) type-D indication of the beam for RS reception; 8) an initial state of a CSI measurement corresponding to the propagation path between the first and second ANs (e.g., a prior CSI measurement when the target UE is not present, a prior CSI measurement associated with the static objects and when target UE is not present within an indicated area of interest for sensing); 9) a CSI measurement type including one or more of AoA, ZoA, RSRP, RSRPP, doppler shift value, delay, ToF, and/or ToA corresponding to one or more detected received propagation path of the transmitted RS by the first AN at the second AN; 10) detection and/or detection probability of the target UE in an indicated area of interest for sensing based on the indicated RCS information related to the UE and/or the UE surroundings; 11) target-UE and/or overall signal strength characteristics which contain information about the quality and strength of the sensing RS signal which can help to determine the accuracy of the information being reported; and/or 12) a detection range which contains information regarding the maximum and minimum detection ranges of a sensing RS system.

In certain embodiments, a subset of sensing measurements and/or reporting is performed upon detection of a target UE within an indicated area of interest for sensing (e.g., detection of the UE according to a power threshold or an indicated probability, detection of the target UE within an indicated initial position estimate with higher than 90% probability). In some embodiments, a target UE detection is determined according to a sum RSRPP measurement of all observed paths within an indicated area of interest (e.g., initial positioning estimate region). In various embodiments, target UE detection is determined according to a sum RSRPP measurement of all additional and/or removed paths within an indicated area of interest (e.g., initial positioning estimate region) relative to an initial CSI state (e.g., a previous CSI measurement with the same Tx and/or Rx setup).

In certain embodiments, sensing measurements at a second AN based on received multiple RSs from one or more ANs are performed separately for each RS transmission and/or each transmitting AN, and subsequently reported separately to the SLMF. In some embodiments, sensing measurement and reporting at a second AN is performed jointly for multiple of the transmitted RS from one or more ANs.

In one implementation, the detection of the target UE is done based on a sum RSRPP of detected new and/or previously detected but eliminated paths at the receiving AN from the multiple RSs transmitted from one or more transmitting (e.g., first) ANs.

In some embodiments, one or more of sensing and/or positioning measurements are performed and/or subsequently reported to the SLMF according to a permissibility condition on detected propagation paths. The permissibility condition may include one or more of: 1) the propagation paths within an angular segment in the azimuth and/or zenith of arrival defined according to a known coordinate system and reference angle and/or direction or the angular information of the first and/or LOS detected path (e.g., +/−20 degrees margin in azimuth and +/−10 degrees margin in the elevation); 2) propagation paths within a delay margin from the first and/or LOS detected propagation path or a known time-reference by the target UE (e.g., within 30 nsec of the detected ToA of the first and/or LOS path); and/or 3) propagation paths correspond to an indicated value margin of doppler shift. In various embodiments, a measurement type and/or reporting are performed on a first N number of received detected paths, where the value N is indicated to a target UE by the SLMF. In certain embodiments, a first measurement type and/or reporting are performed on a first NI number of received detected paths closest to a first arrived path or a known path and a second measurement type and/or reporting are performed on a first N2 number of the received detected paths closest to the first arrived path or a known path. In some embodiments, N closest path are determined as being closest in ToA to a first arrival path (or a known path to the target UE) closest in AoA to the first arrived path (or a known path to the target UE), closest in ZoA to the first arrived path (or a known path to the target UE), or closest in doppler shift to the first arrived path (or a known path to the target UE), wherein the values N, N1, N2 are indicated to the target UE by the SLMF.

In various embodiments, a permissibility condition of a propagation path is determined according to a prior sensing and/or CSI measurement. The permissible propagation paths for measurement and/or reporting may include newly detected paths compared to a prior measurement (e.g., including indication of a criteria for new path detection, e.g., which differ from the previously obtained ToF, AoA, ZoA according to an indicated percentage and/or absolute difference value), eliminated paths compared to a prior measurement, modified paths compared to a prior measurement (e.g., propagation paths with relative or absolute modification of the corresponding RSRPP, AoA, ZoA, ToF and/or ToA or a combination thereof, according to an indicated threshold, e.g., 20% relative modification of any of the said measurements).

In one implementation, the detection of the target UE at a receiver AN is done based on the sum RSRPP (and comparison to an indicated threshold) of the detected new and/or eliminated and/or modified paths based on an indicated criterion for a modified path, belonging to an indicated area of interest for sensing, at the receiving AN from the multiple RSs transmitted from one or multiple transmitting (e.g., first) ANs. In one such implementation, the further sensing measurement and reporting (e.g., doppler estimate and/or AoA and/or ZoA estimate of the detected paths) are performed conditioned on the detection of the UE within the indicated initial potential area.

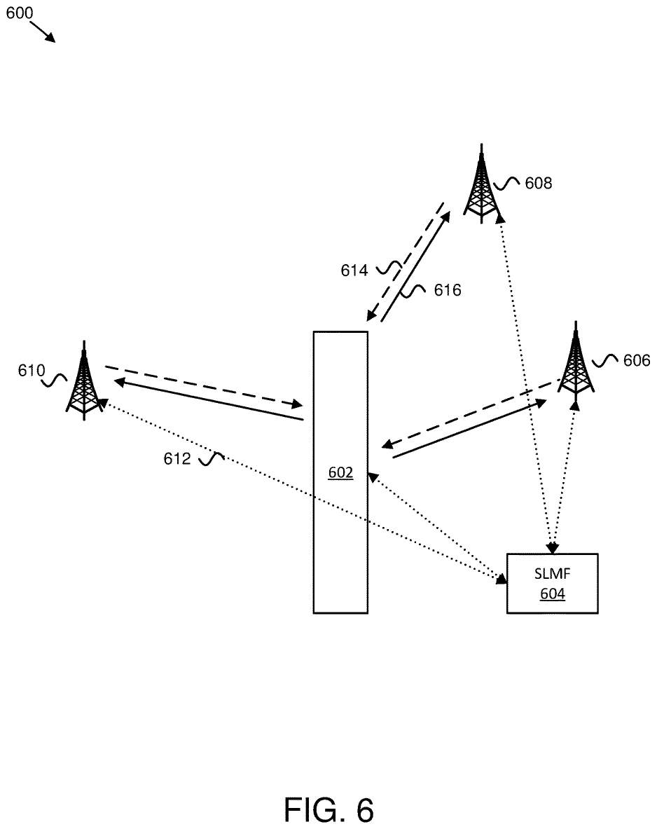

FIG. 6 is a schematic block diagram illustrating one embodiment of a system 600 having a sensing assisted positioning framework. Target UE positioning measurements and radio sensing measurements by ANs are combined to obtain UE positioning-related parameters. The system 600 includes a UE 602, a SLMF 604, a first AN 606 (e.g., AN 1), a second AN 608 (e.g., AN 2), and additional ANs 610 (e.g., AN N). Control signals 612, RS transmission 614, and RS reflection and/or refraction 616 are illustrated showing communications between the devices.

In FIG. 6, an example setup of the sensing aided positioning framework is depicted. Each AN is configured with the transmission of one or more RS and/or configured with the sensing reception and/or measurements on one or more RSs. The ANs participate in the sensing reception and/or measurements, at least in part, based on their capability (e.g., duplexing capability, sensing measurement, and/or processing capability). Anchor nodes may include a RAN node, gNB-CU and/or DU, TRPs, and/or UEs with known locations. In one implementation, each AN is configured with the transmission of a PRS resource (e.g., overall N distinct PRS resource). Moreover, the target UE is configured with the positioning measurement of the transmitted PRSs (e.g., N RS measurements) and all ANs are configured with the sensing measurement of the transmitted RSs (e.g., N×N distinct sensing measurements).

In one implementation, a first gNB and/or TRP transmits a first PRS in the DL and a second gNB and/or TRP transmits a second PRS and a first CSI-RS in the DL, where a first UE (e.g., for which the position is to be estimated) is configured to perform ToA, RSRPP, and AoA measurements based on the received first and second PRS and the first CSI-RS and send a report to the sensing and/or positioning management entity and a second UE (e.g., for which the position is to be estimated) is configured to perform ToA, ToF, RSRPP, and AoA measurements based on the received first and second PRS and the first CSI-RS and send a report to the sensing and/or positioning management entity. Moreover, a third gNB and/or TRP node is configured to perform sensing measurement based on the transmitted first and second PRS and the first CSI-RS and send a first report on a quantized and/or compressed delay-doppler-angle power profile of the measured first channel from the first gNB and a second report on a quantized and/or compressed delay-doppler-angle power profile of the measured second channel from the second gNB and/or TRP to the sensing and/or positioning management entity.

In certain embodiments, obtained assisting information may be used for sensing or positioning measurements (e.g., for reducing the search space of the target UE position, limiting the measured, and/or reported received paths to the paths relevant to the refined angular or delay region). In one implementation, upon receiving updated assisting information indicating a possible target UE location area at an AN directly from the target UE or via the SF, the AN may measure and/or report the ToA, ToF, RSRPP, doppler shift estimate, and/or angle of the detected non LOS (“NLOS”) paths associated with reflection from the updated target UE area.

In some embodiments, an SF is a core network entity responsible for, among others, one or more of: 1) the reception of a sensing information request (e.g., by a sensing client); 2) determination of a method to obtain requested sensing information; 3) collecting capability information of a RAN and/or sensing nodes; 4) requesting, configuring, and obtaining sensing measurements from the sensing nodes; 5) maintaining and/or updating detected object information; 6) computing sensing results from the obtained sensing measurements; and/or 7) exposing the obtained sensing results and/or information to the requesting entity.

In various embodiments, SLMF is an LMF with extended functionality that supports sensing related configurations, measurement reporting collection, and processing. In certain embodiments, SLMF is a combination of two or more entities (e.g., a SF entity responsible for sensing measurements configuration and report collection, sensing measurements processing, and supporting the LMF with the required information). In some embodiments, an SLMF and/or part of the SLMF resides in a RAN node (e.g., a gNB obtains sensing related information and configures and/or performs sensing measurements). In various embodiments, part of the SLMF resides in the RAN network (e.g., a serving gNB, one or more UEs, and/or one or more gNBs), whereas part of the SLMF may reside in a core network (e.g., an LMF and/or an SF). In certain embodiments, an SLMF and/or part of the SLMF resides in a UE node (e.g., a UE obtains sensing related information and configures and/or performs sensing measurements), while the SLMF further includes the LMF residing at a core network. In some embodiments, SLMF includes a location management entity (e.g., LMF) as well as an SF. In various embodiments, an SF resides in a UE, a RAN node (e.g., a gNB), or at the core network. In certain embodiments, a location management entity resides in a UE, a RAN node, and/or at the core network. In some embodiments, when part of the SLMF resides at a RAN network (e.g., serving gNB and/or neighbor gNBs) and another part reside at a core network, coordination and information exchange among different parts of the SLMF are done at least in part via higher layer signaling (e.g., using an NG application protocol (“NGAP”), or embedded within the NR positioning protocol a (“NRPPa”) interface). In various embodiments, when part of the SLMF resides at a UE and another part reside at the core network, coordination and information exchange among different parts of the SLMF are done, at least in part, via a higher layer signaling (e.g., non-access stratum (“NAS”) signaling, or embedded within LTE positioning protocol (“LPP”) messages).

In certain embodiments, one or more parts of a sensing measurement report is configured to be directly transmitted to a target UE, a serving gNB, and/or the other ANs participating in sensing measurement and reporting, wherein positioning measurements at the target UE are performed based on a received sensing measurement report as assisting information. In some embodiments, direct reporting of sensing measurement information is performed periodically, or upon availability of an indicated information (e.g., estimate of AoA and/or ZoA with an indicated accuracy).

In various embodiments, if part of the SLMF resides at a core network and part of the SLMF resides in the RAN network and/or the UEs, the functions of the core-network SLMF and the RAN SLMF are divided according to a known and/or indicated pattern. In one implementation, an SLMF entity residing at the core network (e.g., LMF and/or an SF) receives the initial positioning and/or sensing information request, obtains the node capabilities for positioning and/or sensing measurements, and configures the sensing and/or positioning measurements of the identified nodes. Moreover, a part of the SLMF residing at the RAN (or at a UE) is responsible to initially collect the obtained measurement report, perform a first stage of computation and/or processing of the obtained measurements (e.g., reducing the impact of background environment, known, and/or statis paths, reducing noise, compressing measurements by eliminating the outlier path measurements, and/or performing a rough position estimate of the target UE), report (e.g., dynamically or periodically) parts of the processed measurements to the other RAN nodes (and/or UE ANs) as an updated assisting information, and report the obtained information of the first-stage processed positioning and/or sensing measurements to the core network part of the SLMF. The core network part of the SLMF then collects the received measurements (e.g., after a first stage processing in the RAN), and computes an estimate of the target UE positioning information (e.g., in aggregation of the non-radio access technology (“RAT”) dependent measurements available at the core network).

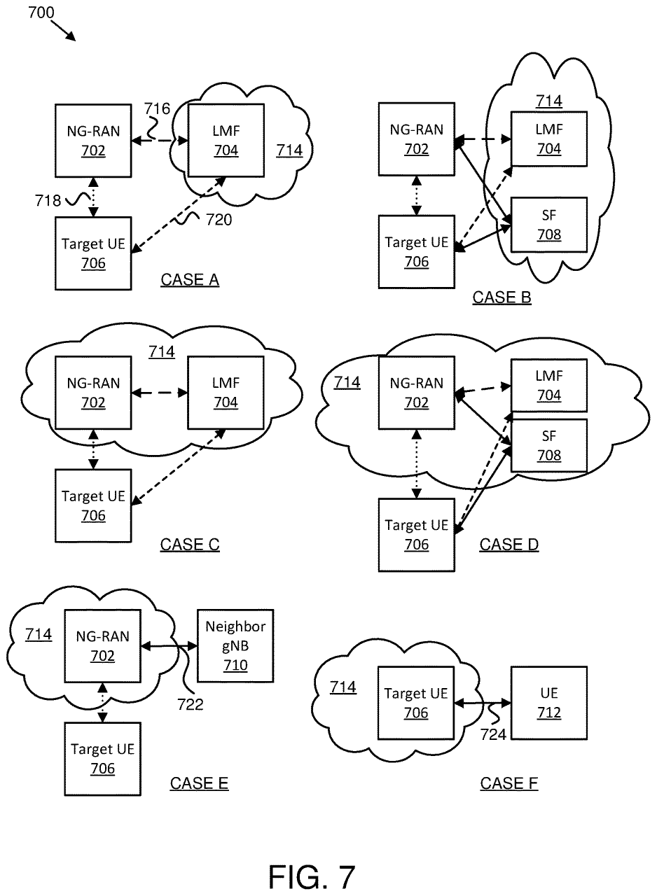

FIG. 7 is a schematic block diagram illustrating embodiments of a systems 700 having different SLMF configurations. Within the cases A, B, C, D, E, and F, an New Generation RAN (“NG-RAN”) 702 (e.g., a RAN used for 5G networks), an LMF 704, a target UE 706, an SF 708, a neighbor gNB 710, and a UE 712 are illustrated with an SLMF 714 including various devices. Moreover, communications NRPPa 716, Uu 718, LPP 720, N2 722, and PC5 724 facilitate communication between the devices. In different implementations of the SLMF 714, the SLMF 714 may be part of the core network, part of a RAN node, and/or part of a UE.

In a first configuration (e.g., case A), the SLMF 714 is implemented as the extended LMF 704, wherein the configuration of the sensing measurement and reporting, the acquisition of the sensing measurements, the configuration of the positioning measurement and reporting, the acquisition of the positioning measurements, and the computation of the target UE 706 position estimate based on the received measurements are performed at least in part at the LMF 704.

In a second configuration (e.g., case B), the SLMF 714 is implemented as a combination of the LMF 704 and the SF 708, wherein the configuration of the sensing measurement and reporting, the acquisition of the sensing measurements, and the computation of the target UE 706 position and/or velocity estimate based on the received sensing measurements are performed at least in part at the SF 708. The configuration of the positioning measurement and reporting, the acquisition of the positioning measurements, and the computation of the target UE 706 position and/or velocity estimate based on the received measurements are performed at least in part at the LMF 704.

In a third configuration (e.g., case C), the SLMF 714 is implemented as a combination of the LMF 704 and a serving gNB (e.g., NG-RAN 702) of the target UE 706, wherein the configuration of the sensing measurement and reporting, the acquisition of the sensing measurements, and the computation of the target UE 706 position and/or velocity estimate based on the received sensing measurements are performed at least in part at the serving gNB. The configuration of the positioning measurement and reporting, the acquisition of the positioning measurements, and the computation of the target UE 706 position and/or velocity estimate based on the received measurements are performed at least in part at the LMF 704.

In a fourth configuration (e.g., case D), the SLMF 714 is implemented as a combination of the LMF 704 and the SF 708 and the serving gNB (e.g., NG-RAN 702) of the target UE 706, wherein the configuration of the sensing measurement and reporting, the acquisition of the sensing measurements, and the computation of the target UE 706 position and/or velocity estimate based on the received sensing measurements are performed at least in part at the SF 708 and/or the serving gNB of the target UE 706. The configuration of the positioning measurement and reporting, the acquisition of the positioning measurements, and the computation of the target UE 706 position and/or velocity estimate based on the received measurements are performed at least in part at the LMF 704.

In a fifth configuration (e.g., case E), the SLMF 714 is implemented as part of a serving gNB (e.g., NG-RAN 702) of the target UE 706, wherein the configuration of the sensing measurement and reporting, the acquisition of the sensing measurements, and the computation of the target UE 706 position and/or velocity estimate based on the received sensing measurements are performed at the serving gNB of the target UE 706. The configuration of the positioning measurement and reporting, the acquisition of the positioning measurements, and the computation of the target UE 706 position and/or velocity estimate based on the received measurements are performed at least in part at the serving gNB of the target UE 706.

In a sixth configuration (e.g., case F), the SLMF 714 is implemented as part of the UE 712 node, wherein the configuration of the sensing measurement and reporting, the acquisition of the sensing measurements, the configuration of the positioning measurement and reporting, the acquisition of the positioning measurements, and the computation of the target UE 706 position and/or velocity estimate based on the received measurements are performed at least in part at the UE 712 node. In some embodiments of the case F, the UE 712 node is an anchor UE node (e.g., with a known position) or the same device as the target UE 706.

In certain embodiments, assisting information for positioning measurements is transmitted to a target UE periodically or semi-statically, wherein the target UE receives additional and/or updated assisting information before the configured positioning measurements are concluded (e.g., before the configured RS resources are received). In some embodiments, the positioning assisting information of the target UE includes sensing measurements of the ANs, the information transmitted from the SF, and/or the information transmitted from the LMF.

In various embodiments, assisting information for sensing measurements is transmitted to an AN periodically or semi-statically, wherein the AN receives additional and/or updated assisting information before configured sensing measurements are concluded (e.g., before the configured RS resources are received). In certain embodiments, sensing assisting information of an AN includes sensing measurements of other ANs, positioning measurements of the target UE, the information transmitted from the SF, and/or the information transmitted from the LMF.

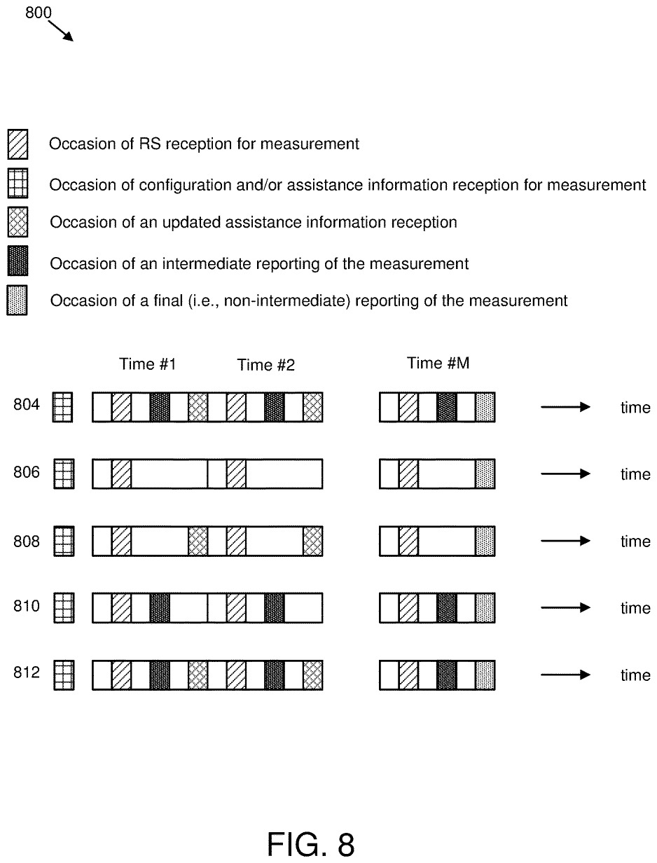

FIG. 8 is a schematic block diagram illustrating embodiments of timing diagrams 800 having different measurement configurations with intermediate reporting and/or an assistance information update. A case A 804, case B 806, case C 808, case D 810, and case E 812 are illustrated.

In certain embodiments, the times in FIG. 8 correspond to a time unit (e.g., an NR of one or more slots). In some embodiments, an order and/or sequence of example configurations is different than the depicted examples in FIG. 8. In various embodiments, a timing distance of two depicted occasions may be unequal, smaller, or bigger than the depicted examples in FIG. 8. In certain embodiments, the times in FIG. 8 correspond to an NR slot, an NR subframe, and/or multiple slots and/or symbols. In some embodiments, one or more illustrated occasions in FIG. 8 are one or more NR symbols, and/or one or more NR slots. In various embodiments, one or more illustrated occasions in FIG. 8 are not identical in their time duration. In certain embodiments, one or more illustrated occasions in FIG. 8 appear with different periodicity (e.g., are present only at even subframes and/or frames). In some embodiments, one or more illustrated occasions in FIG. 8 (e.g., occasion of intermediate report, occasion of the updated assistance information, etc.) are scheduled periodically (e.g., with equal or different periodicity for different occasions), are scheduled dynamically, and/or via semi-persistent scheduling.

In a first configuration (e.g., case A), subsequent to reception of a measurement configuration, including measurement assisting information, at a measurement node (e.g., a target UE configured with positioning measurement and reporting and/or an AN configured with sensing measurement and reporting), the configured measurement is performed based on the first part of the received RS resource based at least in part on the received RS resource and the sensing and/or positioning measurement configuration at the AN and/or target UE. Based on the performed first part of the measurement, an intermediate report is transmitted by the measurement node (e.g., towards the serving gNB of a target UE, a core network entity, or one or more of other measurement nodes, e.g., ANs configured for sensing measurements). Updated assistance and/or configuration information for sensing and/or positioning measurement is received at the measurement node based on which measurement configuration parameters are adjusted for the remaining parts of the RS resources (e.g., adjustment of the Rx beam), adjustment of the permissibility condition of a measurement (e.g., delay and/or doppler margin) based on the estimate of the target UE position and/or velocity based on the part of the received RS. In certain embodiments, updated assisting information is generated at least in part based on the intermediate reports received from the measurement nodes. The report of the performed measurement is then generated based on the received RS resources according to the received measurement and reporting configurations. In some embodiments, configuration of a measurement is based in part on scheduled RS resources and an intermediate reporting configuration is indicated to the measurement node via the positioning or sensing measurement configuration. In various embodiments, configuration of a measurement is based in part on scheduled RS resources and/or an intermediate reporting configuration is indicated to a measurement node by a different node than a SLMF (e.g., a RAN node). In other configurations (e.g., cases B-E), the implementations of the case A hold, wherein one or more of the transmissions of the intermediate measurement reports, and/or the reception of the updated assisting information for measurement at the measurement node are not implemented.

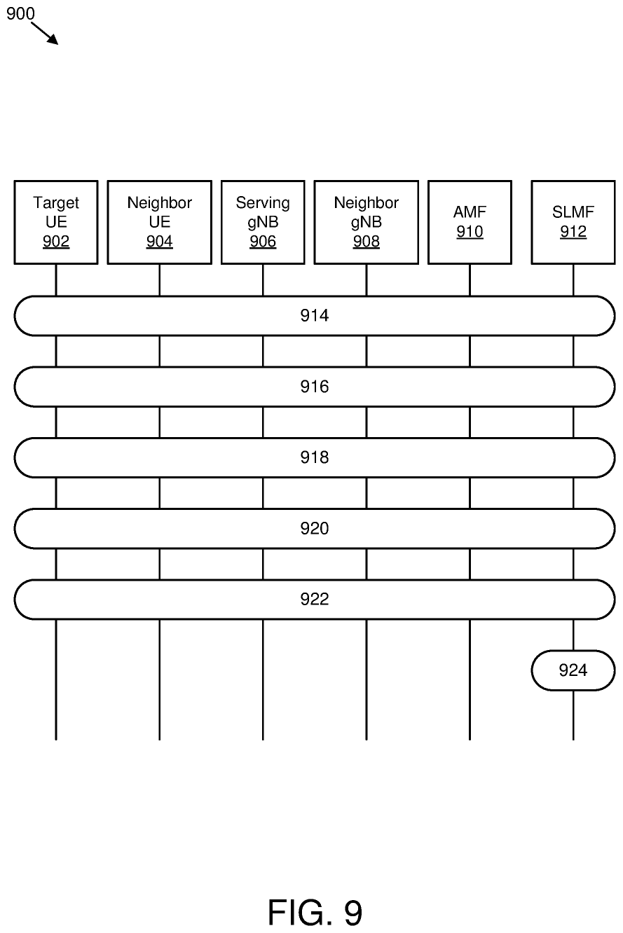

FIG. 9 is a schematic block diagram illustrating one embodiment of communications 900 for joint sensing and positioning measurements. From the example embodiment in FIG. 9, an SLMF may reside in any of the depicted entities. The communications 900 are between a target UE 902, a neighbor UE 904, a serving gNB 906, a neighbor gNB 908, an AMF 910, and a SLMF 912. Each of the communications 900 may include one or more messages.

In a first communication 914, based on a received sensing and/or positioning request and based on obtained capability information of available nodes (e.g., including the target UE 902, the TRPs, anchor UE nodes), the SLMF 912 determines positioning and sensing nodes (e.g., the involved ANs), the RS resources, and measurement configurations.

In a second communication 916, the SLMF 912 identifies the desired assisting information for the environed sensing and/or positioning measurements and obtains the desired assisting information.

In a third communication 918, the SLMF 912 communicates the assisting information to the nodes conducting sensing and/or positioning measurements.

In a fourth communication 920, the SLMF 912 activates the sensing and/or positioning measurements, and the configured nodes (e.g., ANs and the target UE 902) perform the sensing and positioning measurements.

In a fifth communication 922, the performed sensing and/or positioning measurements are reported to the SLMF 912 according to the reporting configuration of the measurements.

The SLMF 912 computes 924 the desired sensing and/or positioning information.

In a second embodiment, there is RS resource scheduling at an SLMF. According to this embodiment, the RS resources for transmission from the ANs, the involved ANs in the sensing and/or positioning process, the type of the sensing measurement, the active and/or muted time-domain RS resources at each AN, the active and/or muted frequency-domain RS resources, and/or the power boosting of RS resources according to a frequency domain pattern are determined by the SLMF, the serving gNB, the NG-RAN, and/or the one or more UEs based at least in part on: 1) available time-frequency resources that can be utilized for RS transmission and/or reception; 2) a duplexing capability of the AN (e.g., indication of whether the AN may act as an RS transmitter and/or RS receiver and/or jointly as transmitter and receiver, and/or jointly as RS transmitter and receiver at least partially at the same time-frequency resource); 3) a capability indication of the target UE for positioning measurements (e.g., supported bandwidth for RS reception and positioning measurement, number of concurrently received RS for measurements, type of the supported measurements); 4) the capability indication of one or more ANs for sensing measurements (e.g., the type of the supported measurements); 5) required key performance indicator (“KPI”) of the positioning information; and/or 6) the observation area of each AN (e.g., the area, according to a global coordinate system, over which the AN may detect a sensing object).

In certain embodiments, a SLMF requests that ANs provide feedback corresponding to a suitability of a proposed resource set by the SLMF (e.g., the AN may accept to reject the proposed resource). Furthermore, the SLMF may indicate an updated RS resource set based on the feedback from the ANs.

In some embodiments, a muted RS at an AN is accompanied with an indication of RS reception and/or sensing measurement at least in part on the same time symbol, the same RE, or the same physical resource block (“PRB”) of the muted RS resource. In one implementation, the muted RS may be indicated via a semi-static configuration indicating which symbols and/or slots are muted or via a bitmap of muted RSs, where ‘1’ refers to a muted resource and ‘0’ represents an unmuted resource.

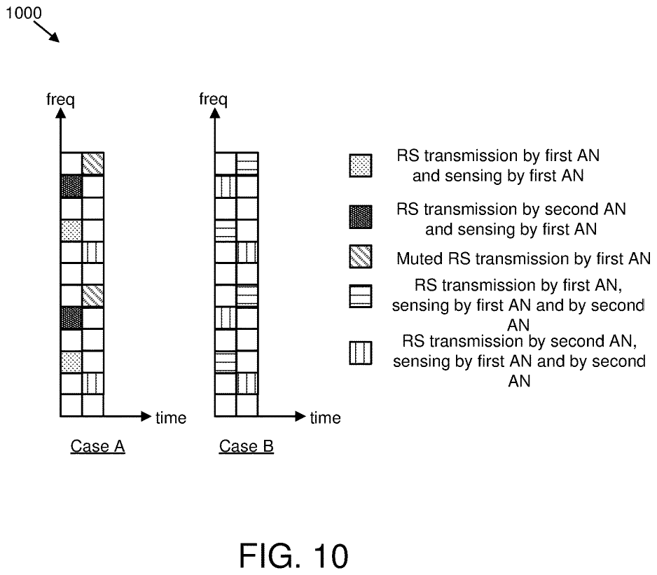

FIG. 10 is a schematic block diagram 1000 illustrating embodiments of RS time-domain muting and/or transmission and sensing according to AN capabilities. In FIG. 10 case B, the first and second ANs are capable of full-duplex operation. As such, the transmission of RS by the first AN is simultaneously sensed by the first and second ANs. Similarly, the transmission of RS by the second AN is simultaneously used for sensing reception and/or measurements by the first and second ANs. In FIG. 10 case A, the second AN is not capable of frequency division (“FD”) operation. Hence, the sensing at the second AN, based on the RS transmitted by the first AN, is performed at the occasions for which the transmission of the RS from second AN is muted.

In various embodiments, first RS configuration parameters (e.g., including frequency domain pattern, center frequency, bandwidth, the sequence generation, and/or sequence to physical resource mapping) are indicated to first ANs for RS transmission, a second RS configuration parameter is indicated to the target UE for positioning measurement, and a third RS configuration parameter is indicated to a second AN for performing sensing measurements based on the transmitted RS based on the first RS configuration parameters.

In certain embodiments, a portion of a RS in a frequency domain is muted, wherein the indication of the muting is accompanied with an indication of a frequency domain resource pattern.

In some embodiments, muting of a portion of the RS resources in a frequency domain is accompanied with a power boosting (e.g., increasing the transmission power of an RE with an indicated ratio) of a non-muted portion of the RS in the frequency domain.

In various embodiments, muting of transmission RS resources of a frequency band at an AN is indicated as being combined with the indication of sensing at the muted frequency band (e.g., when the AN is capable of sub-band full-duplex operation with an indicated resource overlapping capability).

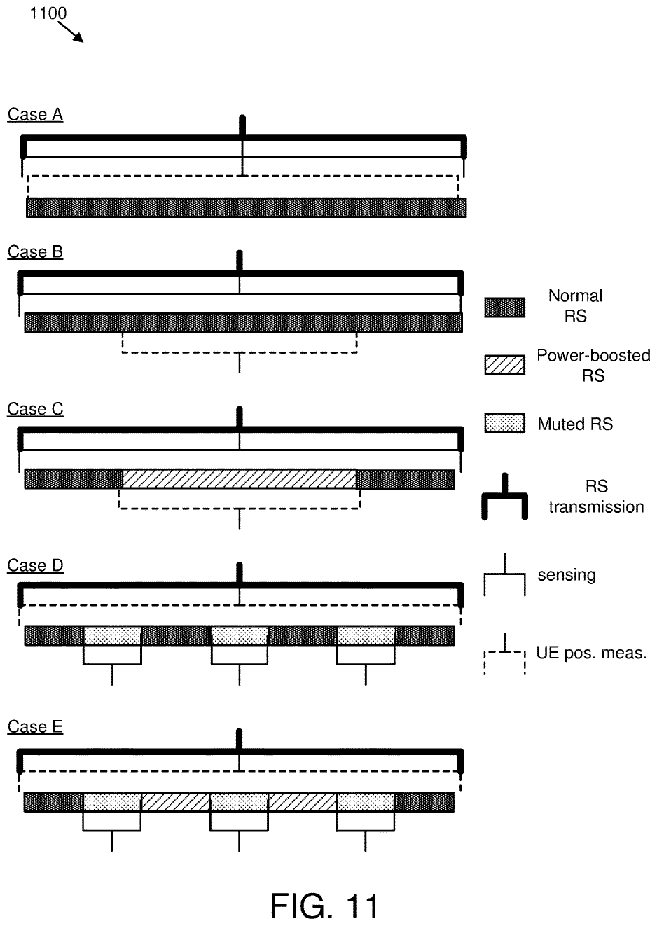

FIG. 11 is a schematic block diagram 1100 illustrating embodiments of RS frequency-domain configurations including muting and power boosting for joint positioning and sensing measurements. FIG. 11 includes a transmission by an AN X, sensing at the AN X, and positioning measurement of the target UE based on the RS transmission of the AN X.

In a first configuration (e.g., case A), sensing of the AN X configured with an RS transmission as well as reception and positioning measurement of a target UE is performed based on the same RS frequency domain pattern (e.g., same bandwidth and using the same RS, e.g., when the AN is capable of full-duplex transmission and reception and the target UE is capable of performing measurements based on the full RS bandwidth). In a second configuration (e.g., case B), the target UE positioning is performed based on a subset of the frequency domain resources of the RS transmission (e.g., due to the limited UE capability for processing the full RS resource), whereas the sensing is performed at the AN X over the full bandwidth of the RS (e.g., sensing is done based on reception of a second RS but at the same time-frequency resource of the first RS). In a third configuration (e.g., case C), the subset of the RS resources that can be received and used for measurement at the target UE is power boosted (e.g., with a potential power reduction of the rest of the band). In a fourth and fifth configuration (e.g., case D and case E), parts of the RS resources are muted, and another part of the frequency domain resources may be power-boosted (e.g., according to the duplexing capability of the AN, wherein the sensing of the AN X is performed at all or subset of the muted RS resources).

In a third embodiment, there may be positioning verification via sensing measurements. According to this embodiment, an LCS client requests verification of a location of a target UE from the LMF, wherein the UE location may not be verified via the target UE positioning measurements (e.g., the UL measurements of a transmitted RS by the target UE and/or DL measurements based on the target UE measurements). As such, the LCS client provides the available location information of the UE and/or requests the location information from the LMF, demanding that the information is verified by means of sensing measurements. In response to the LMF request, an SF performs sensing-based verification of the UE location and provides the LMF with a response.

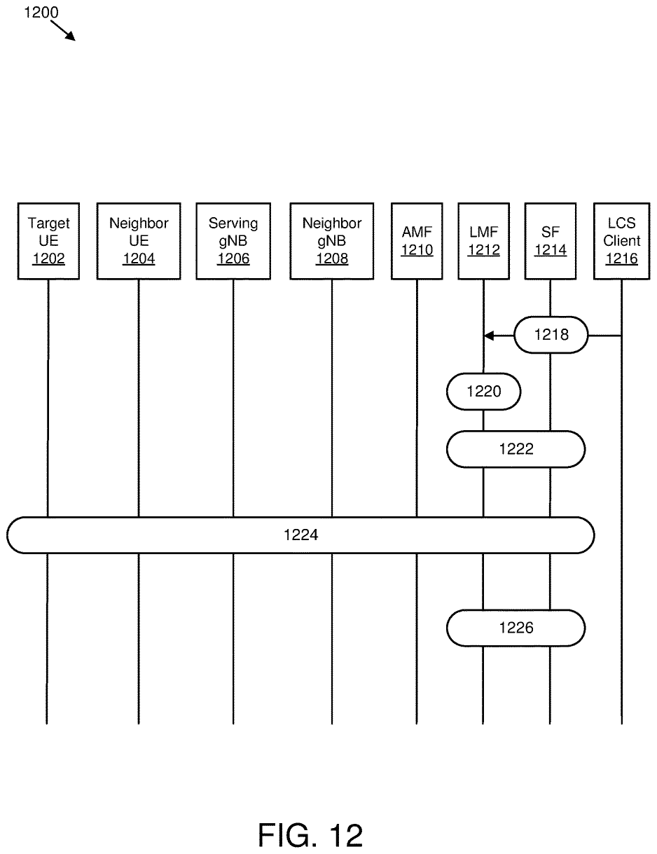

FIG. 12 is a schematic block diagram illustrating one embodiment of communications 1200 for sensing-based UE position verification. In some embodiments, one or more of the messages may not follow the illustrated order and/or sequence. In some embodiments, a message sequence may include at least all or part or a combination of the illustrated steps. The communications 1200 are between a target UE 1202, a neighbor UE 1204, a serving gNB 1206, a neighbor gNB 1208, an AMF 1210, an LMF 1212, an SF 1214, and an LCS client 1216. Each of the communications 1200 may include one or more messages.

In a first communication 1218, the LCS client 1216 requests a sensing-based verification of a target UE 1202 location from the LMF 1212. The request may further include an initial estimate of the target UE 1202 location by the LCS client 1216. Moreover, the request may further include an indication of the tolerance margin for the UE position for verification. Further, the request may include RCS related information of the target UE 1202 (e.g., a car, with a given dimension).

The LMF 1212 may determine 1220 that a sensing-based verification is needed. Moreover, the LMF 1212 may determine that the available positioning information is accurate and further verification is not needed. Further, the LMF 1212 may determine that the target UE 1202 may not be verified via sensing.

In a second communication 1222, the LMF 1212 requests a sensing-based verification of the target UE 1202 location from the SF 1214. In some embodiments, the LMF 1212 indicates to the SF 1214 the available positioning information of the UE as assisting information to perform the sensing measurement. In various embodiments, the LMF 1212 indicates to the SF 1214 the UE size and/or form (e.g., as received in the first communication 1218) and the SF 1214 determines the RCS and/or information on the physical characteristics of the UE and/or UE surroundings as assisting information for SF 1214 verification of the UE location. In certain embodiments, the LMF 1212 further indicates to the SF 1214 one or more tolerance margins (e.g., a location area for the estimated target UE presence), for which a detected target UE 1202 location is indicated to be accurate, verified with errors, and unverified. In one implementation, the LMF 1212 indicates to the SF 1214 a current estimate of the target UE 1202 location, a first tolerance margin of 2 m-radius for an accurate position estimate (e.g., with error below 2 ms), a second tolerance margin of 20 m for a verified with errors, and an unverified UE location condition for the error above the 20 m. In some embodiments, the sensing of the UE is done at the SF 1214 without direct communication and/or input from the target UE 1202 due to the verification nature of the sensing information.

In a third communication 1224, the SF 1214 obtains sensing measurement and/or information corresponding to the target UE 1202.

In a fourth communication 1226, the SF 1214 returns to the LMF 1212 a response to the LMF 1212 request for UE location verification. In certain embodiments, the SF 1214 returns to the LMF 1212 an indication of the UE presence at the defined area by the LCS client 1216. In some embodiments, the SF 1214 indication of the UE presence is accompanied with the location estimate of the SF 1214 and/or the indication of the reliability of the SF 1214 estimate (e.g., a probability indication for the correctness of the determined result). In various embodiments, the SF 1214 indicates to the LMF 1212 that the position verification is not possible. In certain embodiments, the SF 1214 indicates to the LMF 1212 a reason for which the position verification is not possible (e.g., unavailability of the assistance information, e.g., RCS, a too large verification area, unavailability of sensing resources).

In a fourth embodiment, there may be acquisition of UE-related RCS information. According to this embodiment, an SLMF (e.g., the SF) obtains RCS related information of a UE and/or RCS related information of a UE surrounding autonomously (e.g., based on an indication from the UE or a client) or based on a request to obtain RCS information of the UE and/or UE surrounding from the UE.

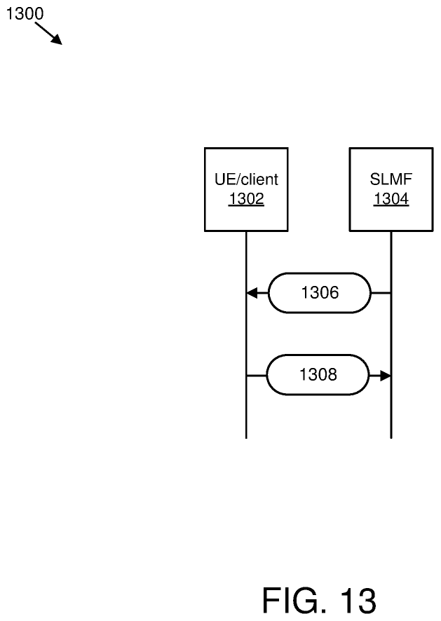

FIG. 13 is a schematic block diagram illustrating one embodiment of communications 1300 for RCS information acquisition relevant to a target UE. A client may be an application layer of the UE, an LCS client, the sensing client and/or request initiator (e.g., an application server using positioning or sensing services, the AMF for a network initiating a request). The message sequence may include at least all or part or a combination of the illustrated steps. The communications 1300 are between a UE 1302 (or client) and an SLMF 1304. Each of the communications 1300 may include one or more messages.

In a first communication 1306, the SLMF 1304 (e.g., SF, LMF, gNB, or another UE) requests from the UE 1302 (or a client) of RCS related information of the UE and/or RCS related information of a UE surrounding.

In a second communication 1308, the UE 1302 responds to the SLMF 1304. The UE 1302 response may include: 1) an indication that RCS-related information is not available; 2) an indication that RCS-related information may not be exposed; 3) an indication that RCS information can be provided, including additional conditions and/or description for the RCS information such as a) a timing for the availability of RCS-related information (e.g., latency), and b) accuracy of RCS related information; and/or 4) RCS related information of the UE 1302 and/or UE surroundings.

In certain embodiments, an SF maintains obtained RCS information of a UE from previous sensing measurements performed with the inclusion of the UE. In such embodiments, the SF may send a query message to the UE to check if the previously obtained RCS information is still valid. Moreover, the UE may respond to the SF query, indicating if the RCS information of the UE and/or UE surroundings is still valid.

In some embodiments, a UE does not provide RCS related information of the UE and/or the UE surroundings but indicates that the RCS-related information is still valid and/or indicates a validity duration and/or time information for the indicated RCS information. In various embodiments, a UE sends an indication of an update and/or change of RCS related information if the UE determines RCS information has changes (e.g., may also include the update).

In certain embodiments, a UE autonomously sends RCS related information of the UE and/or RCS related information of the UE surrounding a SLMF (e.g., SF, LMF, gNB, and/or another UE to facilitate sensing and/or positioning measurements).

In some embodiments, a UE is configured to report information on the UE RCS to a SLMF and/or a serving gNB. In various embodiments, a UE indicates to a network an availability of RCS-related information of the UE and/or the local surroundings. In certain embodiments, a UE indicates to a network the UE capability of obtaining RCS related information of the UE and/or the availability of the RCS-related information of the UE surrounding objects and/or area of the local surroundings. In some embodiments, a capability indication includes a time-window indication that is required by a UE to obtain and report RCS-related information. In various embodiments, a UE indication of availability and/or capability related to UE RCS information further includes an RCS information type. In certain embodiments, an RCS information type is indicated via an index from a codebook, where the codebook includes types of different potential RCS information and/or a resolution and/or accuracy of the RCS information. In some embodiments, different time-window values are indicated for different types of RCS-related information.

In some embodiments, RCS information of a UE may include one or more of: an indication of presence of a reflector (e.g., a RIS), indication of a reflection strategy of a RIS (e.g., where the reflection strategy may include one or more of incidence angle of a RIS, reflection angle of a RIS, and/or a time pattern of a reflection of an incident angle), placement of the RIS on a UE device body (e.g., placement of a RIS on the top of a vehicle in the right corner), and/or a reflection energy and/or efficiency indication (e.g., the 0.1 of the incident energy will be reflected based on the indicated reflection strategy).

RCS information of a UE may include one or more of: 1) an RCS value including a phase shift, a reflection energy and/or strength, and/or a virtual aperture corresponding to one or more of an incident angle, a reflection angle, and/or a frequency band (e.g., RCS of 0.8 dbsm at incident angle of 30-35 degrees of azimuth and 20-30 degrees of elevation and 0.6 dbsm at incident angle of 10-20 degrees of azimuth and 10-20 degrees of elevation); 2) an average RCS value taken for one or more of an incident angle, a reflection angle, and/or a frequency band (e.g., RCS of 0.8 dbsm at incident angle of 30-35 degrees of azimuth averaged for all elevation angles of 10-75 degrees); 3) a velocity of the UE relative to a known reference to the network and the UE (e.g., estimated UE velocity with respect to a static ground); 4) a device orientation with respect to a known coordinate system (e.g., vehicle orientation in a road); 5) an angular velocity of a UE (e.g., wheel dimension and/or speed of the UE or part of a UE, presence of 4 wheels with radius of 70 cm at indicated locations); 6) a device altitude (e.g., estimated distance to the ground), and/or a device distance from a known object by the network; 7) a device shape and/or device form factor (e.g., the UE is a car with a type and/or dimensions of index i, wherein i is an index from a codebook defining different UE types, e.g., a truck with X dimensions, a car with Y dimensions); 8) a radio frequency identifier (“RFID”) tag identifier associated with the target UE; 9) a relative position of an RFID tag to a device body (e.g., if the RFID tag is placed at the top, bottom, left side, and/or right side, the UE may be located according to a global or known coordinated system between the UE and the network); 10) an RFID tag identifier of a UE detected by the target UE (e.g., the target UE discovers other UEs in the neighborhood from which the RFID information (and/or other RCS-related information of the other UEs) are communicated to the target UE and accordingly reported to the network, or a target UE detects one or more RFID tag reflections in its neighborhood and accordingly reports to the network); 11) a relative position of the UE antenna with respect to the device body (e.g., the UE antenna position at a truck, or a car, the UE antenna positioning can be indicated via an index from a codebook, wherein the codebook defines different UE antenna positions for known device objects, e.g., vehicles); 12) observed objects by the UE in the UE surroundings (e.g., distance, type and dimension description of a wall, tree, and/or vehicle observed in the UE vicinity, a vehicle of type “i” (according to a known codebook of the possible vehicle/object types) or with dimension of 2 m by 1 m, at the displacement of (1 m, 1.5 m, 0 m) according to the global coordinate system with respect to the UE); and/or 13) information of propagation paths associated with the observed UE surroundings (e.g., a bitmap description of a blockage map at UE surroundings).

In various embodiments, a UE indicates to an SLMF of the UE capability to obtain RCS related information. In certain embodiments, a UE capability indication includes a type of RCS related information, a latency of obtaining the type of the RCS-related information, and/or an accuracy of the RCS-related information.

In some embodiments, a UE is requested to dynamically report the available RCS related information at the UE to a SLMF (e.g., upon indication of the SLMF, upon availability of new information, and/or upon a change in the previously reported RCS related information of the UE). In various embodiments, a UE is requested to report to a SLMF available RCS related information at the UE periodically, wherein the periodicity of the reporting is indicated by the SLMF as part of a reporting configuration.

In certain embodiments, a UE is configured to report RCS to a node other than a SLMF, wherein the reporting configuration is indicated by the SLMF to a target UE as well as a recipient of the report. In some embodiments, a target UE reports RCS related information to one or more ANs participating in sensing RS reception and measurements.

In various embodiments, a request for RCS related information and/or configuration of reporting of the RCS related information of the target UE and/or the UE surroundings includes an effectiveness criteria according to which the modifications and/or RCS related information will be reported if they satisfy the indicated criteria. In certain embodiments, an effectiveness criterion includes an RCS threshold (e.g., 8 dBs), an RCS modification of 3 dB (e.g., a new RCS value is reported if it differs from a previous one by at least 3dB), a device horizontal surface of 3 sqm, and/or a minimum volume.

In some embodiments, RCS related information is obtained and reported to an SLMF by an AN participating in sensing measurements. In various embodiments, an SLMF requests RCS related information of a target UE from an AN, wherein the AN is configured with a sensing measurement associated with the target UE.

In certain embodiments, RCS related information of a UE, a target UE, one or more objects of interest for sensing, and/or UE surroundings is requested by an SLMF (e.g., LMF, SF, or NG-RAN) from an LCS client, from a sensing service client (e.g., the entity issuing a request for sensing), and/or an application layer of the UE.

In some embodiments, RCS related information of a UE, a target UE, one or more objects of interest for sensing, and/or UE surroundings is provided autonomously to an SLMF (e.g., LMF, SF, or NG-RAN) by an LCS client by a sensing service client (e.g., the entity issuing a request for sensing), and/or by an application layer of the UE.

In various implementations, a sensing client (e.g., an application server or a UE, application layer of a UE) requests 5GS (e.g., SLMF) for the positioning of a target UE and/or requests sensing of an area of interest for a target object, wherein the RCS related information of the target UE and/or the target object is indicated by the client to the 5GS (e.g., SLMF). The indication is done upon request of the SLMF or autonomously by the client. Upon reception of the request and the RCS related information, the SLMF configures a sensing and/or positioning measurement, wherein the RCS related information (or a subset, compressed, and/or modified version thereof) may be used at the SLMF and/or indicated to the sensing and/or positioning measurement nodes as assisting information.

In certain embodiments, acquisition of RCS related information is done within the same message or at a different time and/or message than the client requesting sensing and/or positioning information. In some embodiments, RCS related information of a UE or an object of interest for sensing is reused at multiple time instances, multiple requests of target UE positioning, and/or multiple instances of sensing of the object of interest (e.g., a client indicates the RCS information to the SLMF when subscribed to a service, periodically every day and/or hour, or when the RCS information has been changed, wherein during the time that the indicated RCS-related information is valid, one or more requests for sensing and/or positioning of the associated object and/or UE are issued by the sensing and/or positioning client).

In a fifth embodiment, an LMF may request sensing information from an SF. According to this embodiment, upon reception of a target UE location information request from an LCS client, the LMF determines the need to request sensing information from the SF. Subsequently, the LMF requests sensing information from the SF. Upon reception of the LMF request for sensing measurement and/or information by the SF, the SF configures sensing measurements and reporting of at least one or more ANs including adjustments of the RS transmission, reception and sensing measurements, and reporting configuration from the ANs configures with sensing measurement. The SF computes and/or determines the requested sensing information by the LMF based on the collected sensing measurement reports of the configured ANs, the RCS related information of the target UE and/or the target UE surroundings, and/or prior and/or initial positioning information of the target UE.

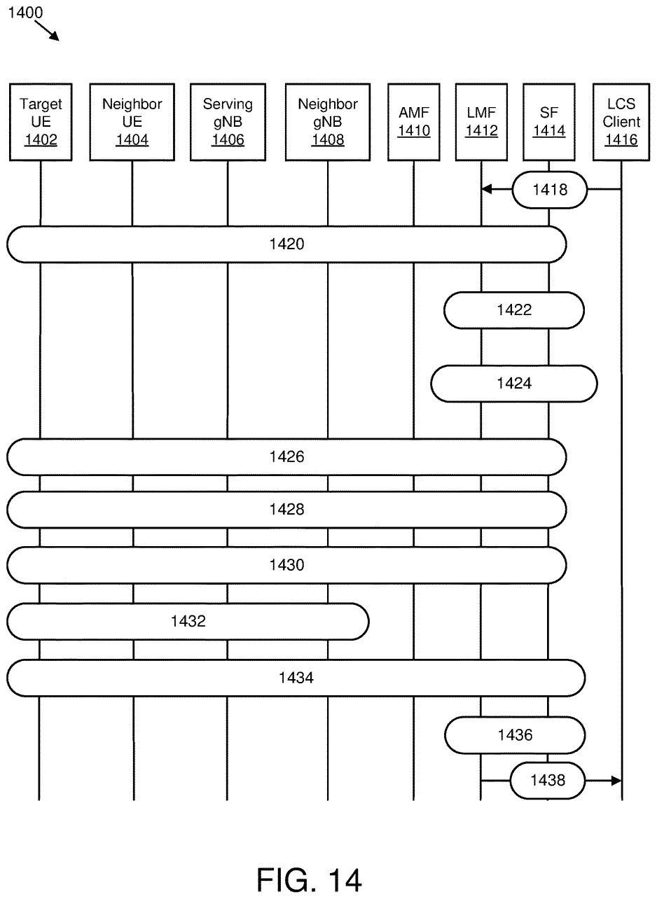

FIG. 14 is a schematic block diagram illustrating one embodiment of communications 1400 for LMF-triggered sensing (e.g., sensing-assisted positioning) in which an LMF requests SF for sensing information. In some embodiments, one or may of the messages may not follow the illustrated order and/or sequence. In various embodiments, the message sequence may include at least all or part or a combination of the illustrated steps. The communications 1400 are between a target UE 1402, a neighbor UE 1404, a serving gNB 1406, a neighbor gNB 1408, an AMF 1410, an LMF 1412, an SF 1414, and an LCS client 1416. Each of the communications 1400 may include one or more messages.

In a first communication 1418, the LCS client 1416 requests positioning information of the target UE 1402 from the LMF 1412. In certain embodiments, the LCS client 1416 request of the target UE 1402 position may include RCS related information of the target UE and/or target UE surroundings, and/or an initial position estimate and/or a permissible area for target UE position.

In a second communication 1420, the LMF 1412 determines if sensing is needed for the target UE 1402 positioning. In some embodiments, the determination of the LMF 1412 may be based on: 1) sensing capability of the network (e.g., indicated (via a dynamic or periodic indication) by the SF 1414 to the LMF 1412 for a particular area, at a particular cell area (e.g., corresponding to an enhanced cell identifier (“CID”)), presence of sensing capable TRPs at the area of interest)—in certain embodiments, the SF 1414 capability indication to the LMF 1412 is done based on an availability and/or possibility to obtain the RCS-related information of the target UE 1402 and/or the target UE 1402 surroundings—this information may be obtained directly from the target UE 1402 and/or from the SF 1414; and/or 2) the requested positioning accuracy of the target UE 1402, and/or the achievable positioning accuracy estimate of the target UE 1402 at the LMF 1412.

In a third communication 1422, the LMF 1412 requests sensing information from the SF 1414. In certain embodiments, the LMF 1412 request of the sensing information includes: 1) an indication of one or more target UEs (e.g., UE IDs); 2) an indication of RCS related information of the UE and/or UE surroundings (e.g., when such information is available at the LMF 1412, e.g., by directly obtaining it from the UE prior to the sensing request); 3) an indication of an initial estimate of the target UE 1402 positioning information (e.g., UE position and/or potential area, orientation, and/or velocity); 4) an indication of a requested sensing information and/or measurement (e.g., reporting RSRPP, doppler shift, and/or ToA of the target UE 1402 reflection or all paths, or a subset of the paths detected by the SF 1414 at any of the ANs configured for sensing measurements), and/or detection of the target UE 1402 presence probability (e.g., obtained by the SF 1414) at one or more potential areas and/or grid areas (e.g., the LMF 1412 requests a probability of the target UE 1402 presence from the SF 1414 for each of the pre-defined 8 area grids); 5) available RS resources (e.g., PRS resources) which can be used for positioning and/or sensing measurements; and/or 6) a tolerable latency of the requested sensing information by the LMF 1412.

In a fourth communication 1424, the SF 1414 responds to the LMF 1412 request. In various embodiments, upon reception of the LMF 1412 request for sensing, the SF 1414 determines if the sensing information can be provided following the LMF 1412 request and responds to the LMF 1412 positively if the requested sensing information and/or measurement can be provided, or negatively if the requested sensing information cannot be obtained at the SF 1414. In certain embodiments, the SF 1414 positive and/or negative decision provided to the LMF 1412 is based at least in part on: 1) the indicated area of interest for a potential target UE 1402 position by the LMF 1412, the initial position estimate of the target UE 1402, the indicated RCS related information of the target UE 1402 and/or UE surrounding, the requested sensing information and/or measurement by the LMF 1412, and/or the indicated RS resources for positioning and/or sensing measurements by the LMF 1412; 2) an available sensing capability of the network (e.g., supported sensing measurements, duplexing capabilities of the available ANs, and/or available ANs at the indicated area of interest (e.g., including the anchor UE and/or gNB and/or TRP ANs)); and/or 3) an availability and the type and/or effectiveness of the RCS related information of the target UE 1402 and/or UE surroundings (e.g., the average RCS value of the UE). Note that the RCS value(s) are in units of decibel relative to one square meter (abbreviated “dbsm”).

In some embodiments, the SF 1414 further provides a reason for a negative response to the LMF 1412, and/or a capability to deliver alternate sensing information based on the evaluated sensing capabilities at the SF 1414. In various embodiments, an SF 1414 response includes a timing for supported reporting of the planned and/or obtained sensing information and/or measurements transmitted to the LMF 1412 (e.g., the requested information will be reported periodically starting from T0 and with a periodicity of Δ_{T}) . In certain embodiments, timing for reporting of the sensing information and/or measurement by the SF 1414 to the LMF 1412 is included in the LMF 1412 request from the SF 1414 for sensing information. In some embodiments, an SF 1414 negative and/or positive response is skipped, wherein the SF 1414 negative response is implicitly indicated based on the lack of an SF 1414 response within an indicated and/or pre-determined time-window, and/or the positive response is implicitly indicated by the SF 1414 by providing the requested sensing information and/or requesting further information of the UE positioning measurements (e.g., request for available PRS resources for positioning measurements and/or the ANs determined by the LMF 1412 for positioning measurements).

In a fifth communication 1426, the SF 1414 and the LMF 1412 may obtain capability information of the target UE 1402 for positioning, neighbor UEs for sensing measurements, serving gNB and neighbor gNBs for sensing, and/or positioning measurements. In various embodiments, acquisition of a capability for sensing and/or positioning measurement is performed at least in part at any of communications 1420 and/or 1424. In certain embodiments, an acquisition of the capability information includes information exchanges between the LMF 1412 and the SF 1414, wherein the LMF 1412 indicates the obtained positioning and/or sensing capability of the candidate nodes for positioning measurements, and the SF 1414 provides to the LMF 1412 the sensing and/or positioning capabilities of the candidate nodes for sensing measurements.

In a sixth communication 1428, the LMF 1412 and the SF 1414 determine positioning and sensing measurement configurations and/or nodes and RS resources and measurement configurations for sensing and positioning measurements of the involved nodes. In some embodiments, determination of the configuration parameters, or a subset thereof for sensing measurements is proposed by the LMF 1412 making a transmission to the SF 1414 at least in part based on the determined positioning configuration parameters and/or capabilities for positioning measurements at the LMF 1412. In response of the LMF 1412 suggestion and/or proposal, the SF 1414 may accept all or a subset of the proposed configuration parameters by the LMF 1412, determine different configuration parameters based at least in part on the LMF 1412 proposal, suggest an alternate configuration parameter for sensing and/or positioning measurements, and/or propose an updated configuration parameter to the LMF 1412. In various embodiments, determination of the configuration parameters or a subset thereof for positioning measurements is proposed by the SF 1414 making a transmission to the LMF 1412 at least in part based on the determined sensing configuration parameters and/or capabilities for sensing measurements at the SF 1414. In response of the LMF 1412 suggestion and/or proposal, the LMF 1412 may accept all or a subset of the proposed configuration parameters by the SF 1414, determine different configuration parameters based at least in part on the SF 1414 proposal, suggest an alternate configuration parameter for positioning and/or measurements, and/or propose the updated configuration parameter to the SF 1414.

In a seventh communication 1430, the LMF 1412 and the SF 1414 provide assistance information to measurement entities. As such, the sensing and/or positioning measurements of the scheduled nodes are based at least in part on the provided assistance information. In certain embodiments, the LMF 1412 provides assistance information for the target UE 1402 for the configured positioning measurements, and the SF 1414 provides assisting information to the ANs scheduled with sensing measurements for the configured sensing measurements. In some embodiments, assistance information for sensing measurements at the configured ANs is provided at least in part by the LMF 1412, the serving gNB or another RAN node, and/or the target UE 1402. In various embodiments, assistance information for positioning measurements at a target UE 1402 is provided at least in part by the SF 1414, the serving gNB or another RAN node, and/or the target UE 1402. In certain embodiments, an assisting information type from an information source (e.g., a 99% reliability region of a target UE 2-D position, as a circle center and a radius value, from the LMF 1412 or from the SF 1414 or an SLMF part residing in NG-RAN) is provided dynamically (e.g., when a new, corrected, and/or updated region is available) or periodically (e.g., indicating the current estimate of the region at a given periodicity). In some embodiments, different types of assisting information from different sources may follow different indication periodicities and/or types.

In an eighth communication 1432, sensing and positioning measurements are performed. The sensing and/or positioning of the nodes are performed at the target UE 1402, the configured neighbor UEs, the serving TRP, and/or the neighbor TRPs according to the received configurations.

In a ninth communication 1434, measurements may be obtained by the SF 1414 and the LMF 1412. In some embodiments, performed sensing and/or positioning measurements are obtained by the SF 1414 and/or the LMF 1412.

In a tenth communication 1436, there may be computation of a target position. In various embodiments, the computation of the target UE 1402 positioning information is performed at the SF 1414 and/or at the LMF 1412. In certain embodiments, sensing measurements are initially processed by the SF 1414, and a processed sensing measurement (e.g., removal of irrelevant and/or outlier path measurements, detection of a target UE 1402 presence at one or multiple of hypothetical location areas, path measurements with the elimination of the static and/or non-related reflections to the target UE 1402, and/or a separate target UE 1402 position estimate based on sensing measurements) is generated and/or obtained at the SF 1414 and indicated to the LMF 1412. In some embodiments, the LMF 1412 aggregates different measurements from the one or more sensing measurement nodes, the target UE 1402, the positioning measurements at the ANs of the UL RS transmitted by the target UE 1402, and/or available RAT independent positioning information of the UE.

In an eleventh communication 1438, a positioning information response is communicated. The LMF 1412 reports the obtained positioning estimate of the target UE 1402 to the LCS client 1416.

In a sixth embodiments, an SF may request positioning information from an LMF. According to this embodiment, upon reception of a sensing request by a sensing service client (e.g., via the network exposure function (“NEF”) or via the RAN for a sensing task within an area of interest for monitoring), the SF requests presence and/or positioning information from the LMF (e.g., position, velocity, and/or orientation), the RCS related information of the UEs, and/or the UE neighborhood within an area of interest for sensing. Upon reception of the SF request, the LMF determines the presence of the UEs within the indicated location area indicated by the SF and responds to the SF based on the obtained position and/or positioning information of the UEs.

In various embodiments, an SF requests UE related information from an LMF that includes a timing information associated with the requested UE presence and/or positioning information (e.g., a time window at which the UE presence and/or valid positioning information within that time window may be determined by the LMF). As such, the LMF may estimate the UE presence and/or positioning information for the indicated time window in the future. In certain embodiments, an SF request includes a tolerable latency indication according to which the LMF may provide the requested information.

In certain embodiments, an SF request from a LMF may include additional criterion corresponding to reported UEs of interest and/or UE capabilities (e.g., UEs which are static) following an indicated velocity pattern, UEs for which RCS information is available and/or the RCS information is above a threshold (e.g., RCS of the UE and/or the UE surrounding is available and is above an indicated threshold), and/or UEs which are capable of radio sensing measurements.

In some implementations, an SF requests that an LMF identify the UEs that are present in a desired road section and/or a 5-meter radius at a time window of 2 secs into the future. Furthermore, it may be further indicated in the SF request that the UE of interest for which the presence and/or position and/or velocity and/or RCS information is of interest, may be static (e.g., absolute velocity of less than 1 m/sec), and/or may be capable of radio sensing measurements and reporting based on an indicated RS type and/or hold an RCS of 1 dbsm or higher (e.g., may vary in different implementations). Moreover, the requested information may be obtained by the SF within 10 msec of the request time stamp.

In various embodiments, an SF request may include an indication of a set of UEs (e.g., UE IDs) for which the indicated information is requested (e.g., requesting if a particular UE is present within an indicated area of interest).

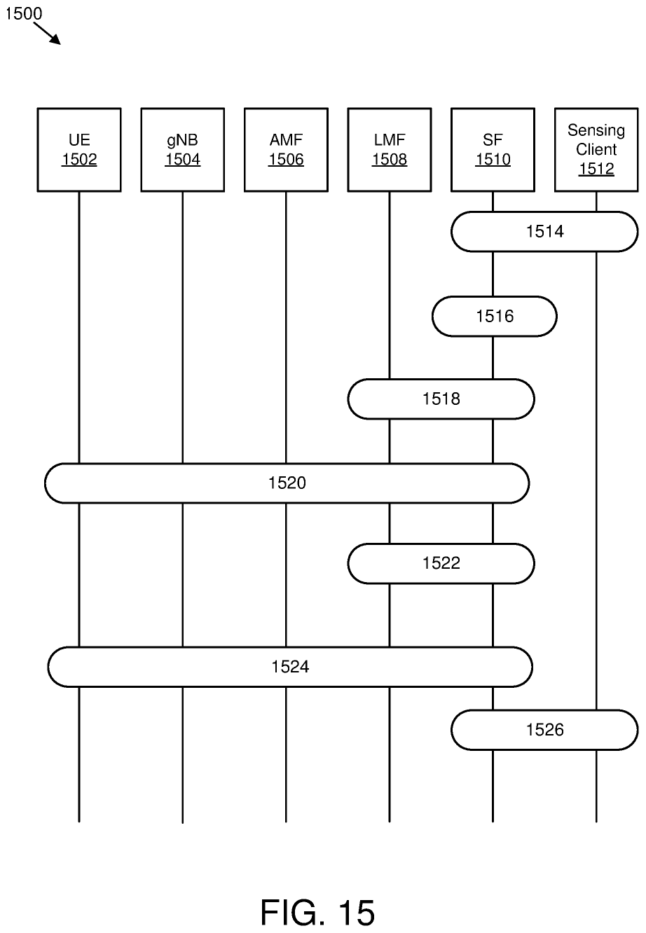

FIG. 15 is a schematic block diagram illustrating one embodiment of communications 1500 for an LMF-assisted sensing procedure in which an SF requests UE presence and/or positioning information from an LMF. In certain embodiments, one or more of the illustrated messages may not follow the illustrated order and/or sequence. In some embodiments, the message sequence may include at least all or part or a combination of the illustrated steps. The communications 1500 are between a target UE 1502, a neighbor UE 1504, an AMF 1506, an LMF 1508, an SF 1510, and a sensing client 1512. Each of the communications 1500 may include one or more messages.

In a first communication 1514, a sensing information request may be received by the SF 1510 from the sensing client 1512.

In a second communication 1516, the SF 1510 determines if assisting information is needed from the LMF 1508. In various embodiments, a determination is based on an available capability of the SF 1510 for sensing (e.g., if a sufficient number of the nodes are available for the sensing task) and/or known statistics of the UE presence within the area of interest for sensing.

In a third communication 1518, the SF 1510 requests sensing assistance information from the LMF 1508.

In a fourth communication 1520, the LMF 1508 obtains requested sensing assisting information.

In a fifth communication 1522, the LMF 1508 provides assistance information.

In a sixth communication 1524, the SF 1510 obtains the requested sensing information.

In a seventh communication 1526, the SF 1510 provides the sensing information.

In certain embodiments, upon reception of a request for sensing information at an area of interest for sensing by an SF, the SF requests the presence information of the UEs at the indicated area of interest from the LMF. The LMF may determine the presence of the UEs based on the prior UE positioning information or may request NG-RAN nodes for determining the UE presence and/or positioning information at a given area of interest. The obtained UE information (e.g., a list of the present UE IDs, UE position and/or velocity information, and/or the UE RCS information) is then delivered to the SF.

In some embodiments, an SF request indicates a reporting and/or response time pattern, wherein the requested information by the SF is reported periodically and/or dynamically (e.g., when previously indicated information changes and/or when a new request is issued).

In various embodiments, an SF requests UE position tracking from an LMF (and periodic reporting of the updated positioning information).

In certain embodiments, an LMF determining requested positioning information further includes requesting information including a UE presence within an indicated area, UE position and/or velocity information, a UE ID, and/or UE RCS related information from a RAN node.

In some embodiment, an SF request for UE information may include UE presence within an indicated area, UE position and/or velocity information, a UE ID, and/or UE RCS related information from a RAN node.

In various embodiments, upon reception of an SF or LMF request by a RAN node, the RAN node determines requested information of the SF and provides a response to the SF. In one implementation, the RAN node determining the requested information includes transmitting a paging request within the requested area.

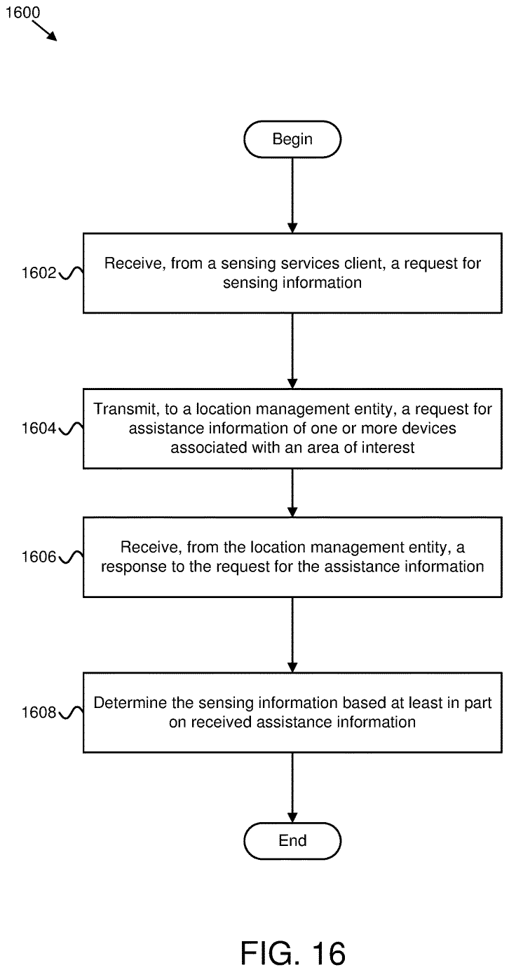

FIG. 16 is a flow chart diagram illustrating one embodiment of a method 1600 for requesting assistance information in association with a sensing request. Note that the target device may be a UE device, a RAN node, an NCR device, a RIS, an IAB node, or a combination thereof. In some embodiments, the method 1600 is performed by an apparatus, such as the remote unit 102 and/or the network unit 104. In certain embodiments, the method 1600 may be performed by a processor executing program code, for example, a microcontroller, a microprocessor, a CPU, a GPU, an auxiliary processing unit, a FPGA, or the like.

In various embodiments, the method 1600 includes receiving 1602, from a sensing services client, a request for sensing information. In certain embodiments, the method 1600 includes transmitting 1604, to a location management entity, a request for assistance information of one or more devices associated with an area of interest. In certain embodiments, the method 1600 includes receiving 1606, from the location management entity, a response to the request for the assistance information. In certain embodiments, the method 1600 includes determining 1608 the sensing information based at least in part on received assistance information.

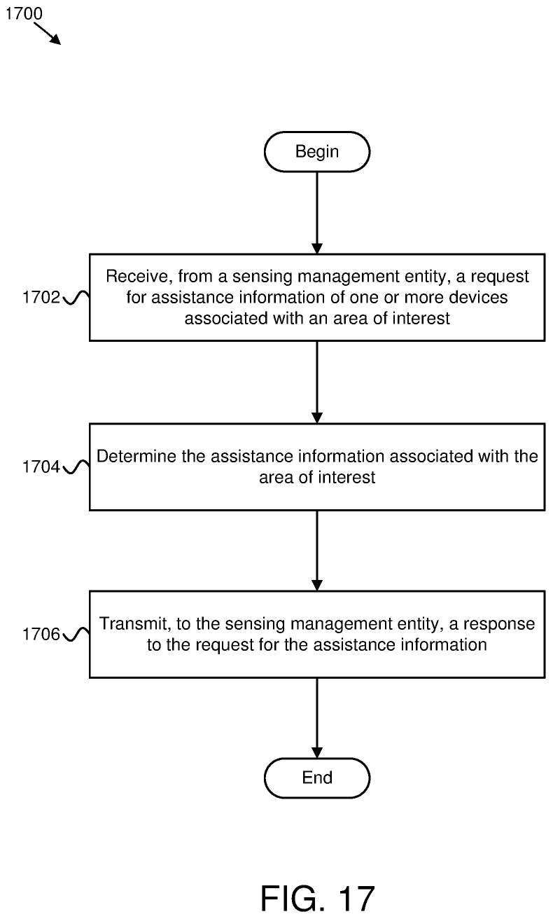

FIG. 17 is a flow chart diagram illustrating another embodiment of a method 1700 for requesting assistance information in association with a sensing request. Note that the target device may be a UE device, a RAN node, an NCR device, a RIS, an IAB node, or a combination thereof. In some embodiments, the method 1700 is performed by an apparatus, such as the remote unit 102 and/or the network unit 104. In certain embodiments, the method 1700 may be performed by a processor executing program code, for example, a microcontroller, a microprocessor, a CPU, a GPU, an auxiliary processing unit, a FPGA, or the like.

In various embodiments, the method 1700 includes receiving 1702, from a sensing management entity, a request for assistance information of one or more devices associated with an area of interest. In certain embodiments, the method 1700 includes determining 1704 the assistance information associated with the area of interest. In certain embodiments, the method 1700 includes transmitting 1706, to the sensing management entity, a response to the request for the assistance information.

A first apparatus is disclosed for requesting assistance information in association with a sensing request. In some embodiments, the first apparatus is embodied as the remote unit 102, the network unit 104, or the like. In certain embodiments, the first apparatus includes a processor executing program code, for example, a microcontroller, a microprocessor, a CPU, a GPU, an auxiliary processing unit, a FPGA, or the like.

In one embodiment, the first apparatus includes a processor and a memory. In one embodiment, the memory includes instructions that are executable by the processor to cause the first apparatus to receive, from a sensing services client, a request for sensing information. In one embodiment, the instructions are further executable by the processor to cause the first apparatus to transmit, to a location management entity, a request for assistance information (e.g., presence and/or positioning information) of one or more devices associated with an area of interest (e.g., according to indicated permissibility criteria). Note that the area of interest may be provided in the request or may be determined by the first apparatus. In one embodiment, the instructions are further executable by the processor to cause the first apparatus to receive, from the location management entity, a response to the request for the assistance information. In one embodiment, the instructions are further executable by the processor to cause the first apparatus to determine the sensing information based at least in part on received assistance information.

In one embodiment, the assistance information comprises positioning information associated with the one or more devices.

In one embodiment, the instructions are further executable by the processor to cause the first apparatus to determine to request the assistance information from the location management entity (i.e., if requesting LMF and what information to request), wherein the determination to request the assistance information is based on permissibility information comprising one or more of: A) the area of interest (e.g., the area of interest may be given to the SF, or may be determined within the SF); B) a minimum device size; C) a value range of a RCS-related information type (e.g., a minimum device size, a minimum average RCS of 10 dbsm); D) a velocity margin of the one or more devices (e.g., UEs with min absolute velocity of 1 m/sec); E) a device capability for sensing measurements (e.g., devices within an area of interest for sensing and can performing sensing RS transmission, sensing RS reception and sensing measurement, or a combination thereof); or F) a combination thereof. Note that case (E) is applicable when there is a UE information request for the purpose of finding capable UEs for sensing of an area.

In one embodiment, the request for the assistance information (i.e., SF request of the LMF) comprises an indication for one or more of: A) a presence of the one or more devices within the area of interest; B) positioning information associated with the one or more devices; C) velocity information associated with the one or more devices; D) a device identifier (e.g., a temporary identifier of a UE for further communication and message exchange between the SF to the UE); E) RCS-related information associated with the one or more devices (e.g., of a device itself or its surrounding); F) a set of KPIs for the assistance information (e.g., accuracy/reliability of the reported device presence or device position information of device velocity information); or G) a combination thereof.

In one embodiment, the request for the assistance information (i.e., SF request of the LMF) comprises first timing information (e.g., a time point or window of time) associated with a validity period of the assistance information. (e.g., the presence of a UE at an indicated time of future).

In one embodiment, the first timing information comprises one or more of: A) a future time point for an estimated presence of the one or more devices; B) a future time point for an estimated position associated with the one or more devices; C) a window of time during which to determine presence information associated with the one or more devices; D) a window of time during which to determine positioning information associated with the one or more devices; or E) a combination thereof.

In one embodiment, the request for the assistance information (i.e., SF request of the LMF) further includes second timing information indicating a reporting configuration for the assistance information.

In one embodiment, the second timing information comprises one or more of: A) a reporting start time; B) a reporting periodicity (e.g., delta); C) a reporting duration; D) a reporting end time; or E) a combination thereof.

In one embodiment, the second timing information indicates a reporting time for the assistance information, wherein the first timing information indicates a validity period at a future time later than the reporting time (e.g., the presence of the UE devices are predicated at 3 secs from the time reference, but the predicted information reported after 1 sec of the time reference).

In one embodiment, the first timing information indicates a set of reporting occasions for the response to the request for the assistance information.

In one embodiment, the response to the request for the assistance information (i.e., LMF response to SF) comprises one or more of: A) a respective device identifier for each of the one or more devices associated with the area of interest that satisfies a set of permissibility criteria; B) respective spatial position information for each of the one or more devices associated with the area of interest that satisfies a set of permissibility criteria; C) a presence indication of the one or more devices associated with an area of interest; D) a presence probability indication of the one or more devices associated with an area of interest; E) respective velocity information for each of the one or more devices associated with the area of interest that satisfies a set of permissibility criteria; F) RCS-related information associated with the one or more devices; G) respective capability information for sensing measurements for each of the one or more devices associated with the area of interest; or H) a combination thereof.

In one embodiment, the response to the request for the assistance information (i.e., LMF response to SF) comprises a negative response (e.g., incapability) indicating that the assistance information is unattainable according to the request.

In one embodiment, the instructions are further executable by the processor to cause the first apparatus to infer a negative response to the request for assistance information after a known time-interval of not receiving a response from the location management entity.

In one embodiment, the negative response further comprises: A) a cause value (e.g., a reason indicated via an index/value) associated with the negative response; B) a reason for the negative response; (e.g., LMF may not estimate/predict a subset of the permissibility condition parameters); C) a proposed modification to the request for the assistance information; or D) a combination thereof.

In one embodiment, the negative response comprises an indication that none of the one or more devices associated with the area of interest satisfy a set of permissibility criteria.

In one embodiment, the instructions are further executable by the processor to cause the first apparatus to infer that none of the one or more devices associated with the area of interest satisfy a set of permissibility criteria after a known time-interval of not receiving a response from the location management entity.

In one embodiment, the instructions are further executable by the processor to cause the first apparatus to report the sensing information to the sensing services client.

In one embodiment, the one or more devices include at least one UE.

In one embodiment, the one or more devices include at least one RAN node.

In one embodiment, the first apparatus comprises a sensing management entity (e.g., a SF), a RAN node, or a combination thereof.

In one embodiment, the first apparatus is implemented as part of a core network, as part of a RAN, as a UE device, or a combination thereof.

A first method is disclosed for requesting assistance information in association with a sensing request. In certain embodiments, the first method is performed by a sensing management entity, such as a standalone SF or an SF portion of an SLMF. In some embodiments, the first method is performed by an apparatus, such as the remote unit 102, the network unit 104, or the like. In certain embodiments, the first method may be performed by a processor executing program code, for example, a microcontroller, a microprocessor, a CPU, a GPU, an auxiliary processing unit, a FPGA, or the like.

In one embodiment, the first method includes receiving, from a sensing services client, a request for sensing information. In one embodiment, the first method includes transmitting, to a location management entity, a request for assistance information (e.g., presence and/or positioning information) of one or more devices associated with an area of interest (e.g., according to indicated permissibility criteria). In one embodiment, the first method includes receiving, from the location management entity, a response to the request for the assistance information. In one embodiment, the first method includes determining the sensing information based at least in part on received assistance information.

In one embodiment, the first method includes reporting the sensing information to the sensing services client.

In one embodiment, the assistance information comprises positioning information associated with the one or more devices.

In one embodiment, the first method includes determining to request the assistance information from the location management entity (i.e., if requesting LMF and what information to request) based on permissibility information comprising one or more of:
the area of interest; (e.g., the area of interest may be given to the SF, or may be determined within the SF)
a minimum device size;
a value range of a RCS information type; (e.g., a minimum device size, a minimum average RCS of 10 dbsm)
a velocity margin of the one or more devices; (e.g., UEs with min absolute velocity of 1 m/sec)
a device capability for sensing measurements; (e.g., devices within an area of interest for sensing and can performing sensing RS transmission, sensing RS reception and sensing measurement, or a combination thereof)
or a combination thereof.

In one embodiment, the request for the assistance information (i.e., SF request of the LMF) comprises an indication for one or more of:
a presence of the one or more devices within the area of interest;
positioning information associated with the one or more devices;
velocity information associated with the one or more devices;
a device identifier; (e.g., a temporary identifier of a UE for further communication and message exchange between the SF to the UE)
RCS information associated with the one or more devices; (e.g., of a device itself or its surrounding)
a set of KPIs for the assistance information; (e.g., accuracy/reliability of the reported device presence or device position information of device velocity information)
or a combination thereof.

In one embodiment, the request for the assistance information (i.e., SF request of the LMF) comprises first timing information (e.g., a time point or window of time) associated with a validity period of the assistance information. (e.g., the presence of a UE at an indicated time of future)

In one embodiment, the first timing information comprises one or more of:
a future time point for an estimated presence of the one or more devices;
a future time point for an estimated position associated with the one or more devices;
a window of time during which to determine presence information associated with the one or more devices;
a window of time during which to determine positioning information associated with the one or more devices;
or a combination thereof.

In one embodiment, the request for the assistance information (i.e., SF request of the LMF) further includes second timing information indicating a reporting configuration for the assistance information.

In one embodiment, the second timing information comprises one or more of:
a reporting start time;
a reporting periodicity (e.g., delta);
a reporting duration;
a reporting end time;
or a combination thereof.

In one embodiment, the second timing information indicates a reporting time for the assistance information, wherein the first timing information indicates a validity period at a future time later than the reporting time. (e.g., the presence of the UE devices is predicated at 3 secs from the time reference, but the predicted information reported after 1 sec of the time reference)

In one embodiment, the first timing information indicates a set of reporting occasions for the response to the request for the assistance information.

In one embodiment, the response to the request for the assistance information (i.e., LMF response to SF) comprises one or more of:
a respective device identifier for each of the one or more devices associated with the area of interest that satisfies a set of permissibility criteria;
respective spatial position information for each of the one or more devices associated with the area of interest that satisfies a set of permissibility criteria;
a presence indication of the one or more devices associated with an area of interest;
a presence probability indication of the one or more devices associated with an area of interest;
respective velocity information for each of the one or more devices associated with the area of interest that satisfies a set of permissibility criteria;
RCS information associated with the one or more devices;
respective capability information for sensing measurements for each of the one or more devices associated with the area of interest;
or a combination thereof.

In one embodiment, the response to the request for the assistance information (i.e., LMF response to SF) comprises a negative response (e.g., incapability) indicating that the assistance information is unattainable according to the request.

In one embodiment, the negative response further comprises:
a cause value (e.g., a reason indicated via an index/value) associated with the negative response;
a reason for the negative response; (e.g., LMF may not estimate/predict a subset of the permissibility condition parameters)
a proposed modification to the request for the assistance information;
or a combination thereof.

In one embodiment, the negative response comprises an indication that none of the one or more devices associated with the area of interest satisfy a set of permissibility criteria.

In one embodiment, the first method includes reporting the sensing information to the sensing services client.

In one embodiment, the one or more devices include at least one UE.

In one embodiment, the one or more devices include at least one RAN node.

In one embodiment, the sensing management entity comprises a network function [i.e., SF], a RAN node, or a combination thereof.

In one embodiment, the sensing management entity is implemented as part of a core network, as part of a RAN, as a UE device, or a combination thereof.

A second apparatus is disclosed for requesting assistance information in association with a sensing request. Note that the target device may be a UE device, a RAN node, an NCR device, a RIS, an IAB node, or a combination thereof. In some embodiments, the second apparatus is embodied as the remote unit 102, the network unit 104, or the like. In certain embodiments, the second apparatus includes a processor executing program code, for example, a microcontroller, a microprocessor, a CPU, a GPU, an auxiliary processing unit, a FPGA, or the like.

In one embodiment, the second apparatus includes a processor and a memory. In one embodiment, the memory includes instructions that are executable by the processor to cause the second apparatus to receive, from a sensing management entity, a request for assistance information (e.g., presence and/or positioning information) of one or more devices associated with an area of interest (e.g., according to indicated permissibility criteria). In one embodiment, the instructions are further executable by the processor to cause the second apparatus to determine the assistance information associated with the area of interest. Note that the area of interest may be received in the request for assistance information or may be (e.g., wholly or partially) obtained based on LMF negotiations/request from the RAN. In one embodiment, the instructions are further executable by the processor to cause the second apparatus to transmit, to the sensing management entity, a response to the request for the assistance information.

In one embodiment, the assistance information comprises positioning information associated with the one or more devices.

In one embodiment, the request for the assistance information (i.e., SF request of the LMF) comprises an indication for one or more of: A) a presence of the one or more devices within the area of interest; B) positioning information associated with the one or more devices; C) velocity information associated with the one or more devices; D) a device identifier (e.g., a temporary identifier of a UE for further communication and message exchange between the SF to the UE); E) RCS-related information associated with the one or more devices; (e.g., of a device itself or its surrounding); F) a set of KPIs for the assistance information; (e.g., accuracy/reliability of the reported device presence or device position information of device velocity information); or G) a combination thereof.

In one embodiment, the request for the assistance information (i.e., SF request of the LMF) comprises first timing information (e.g., a time point or window of time) associated with a validity period of the assistance information (e.g., the presence of a UE at an indicated time of future).

In one embodiment, the first timing information comprises one or more of: A) a future time point for an estimated presence of the one or more devices; B) a future time point for an estimated position associated with the one or more devices; C) a window of time during which to determine presence information associated with the one or more devices; D) a window of time during which to determine positioning information associated with the one or more devices; or E) a combination thereof.

In one embodiment, the request for the assistance information (i.e., SF request of the LMF) further includes second timing information indicating a reporting configuration for the assistance information.

In one embodiment, the second timing information comprises one or more of: A) a reporting start time; B) a reporting periodicity (e.g., delta); C) a reporting duration; D) a reporting end time; or E) a combination thereof.

In one embodiment, the second timing information indicates a reporting time for the assistance information, wherein the first timing information indicates a validity period at a future time later than the reporting time (e.g., the presence of the UE devices are predicated at 3 secs from the time reference, but the predicted information reported after 1 sec of the time reference).

In one embodiment, the instructions are further executable by the processor to cause the second apparatus to report the assistance information to the sensing management entity according to the reporting configuration.

In one embodiment, the first timing information indicates a set of reporting occasions for the response to the request for the assistance information.

In one embodiment, the instructions are further executable by the processor to cause the second apparatus to transmit the response to the request for the assistance information (i.e., LMF response to SF) only when the assistance information is updated (e.g., a new device has satisfied the permissibility condition, a device information (e.g., position/velocity or RCS estimate) has been changed).

In one embodiment, the response to the request for the assistance information (i.e., LMF response to SF) comprises one or more of: A) a respective device identifier for each of the one or more devices associated with the area of interest that satisfies a set of permissibility criteria; B) respective spatial position information for each of the one or more devices associated with the area of interest that satisfies a set of permissibility criteria; C) respective velocity information for each of the one or more devices associated with the area of interest that satisfies a set of permissibility criteria; D) RCS-related information associated with the one or more devices; E) respective capability information for sensing measurements for each of the one or more devices associated with the area of interest; or F) a combination thereof.

In one embodiment, the response to the request for the assistance information (i.e., LMF response to SF) comprises a negative response (e.g., incapability) indicating that the assistance information is unattainable according to the request.

In one embodiment, the negative response further comprises: A) a cause value (e.g., a reason indicated via an index/value) associated with the negative response; B) a reason for the negative response (e.g., LMF may not estimate/predict a subset of the permissibility condition parameters); C) a proposed modification to the request for the assistance information; or D) a combination thereof.

In one embodiment, the negative response comprises an indication that none of the one or more devices associated with the area of interest satisfy a set of permissibility criteria.

In one embodiment, the one or more devices include at least one UE.

In one embodiment, the one or more devices include at least one RAN node.

In one embodiment, the second apparatus comprises a location management entity (e.g., an LMF), a RAN node, or a combination thereof.

In one embodiment, the second apparatus is implemented as part of a core network, as part of a RAN, as a UE device, or a combination thereof.

A second method is disclosed for requesting assistance information in association with a sensing request. In certain embodiments, the second method is performed by a sensing management entity, such as a standalone LMF or an LMF portion of an SLMF. In some embodiments, the second method is performed by an apparatus, such as the remote unit 102, the network unit 104, or the like. In certain embodiments, the second method may be performed by a processor executing program code, for example, a microcontroller, a microprocessor, a CPU, a GPU, an auxiliary processing unit, a FPGA, or the like.

In one embodiment, the second method includes receiving, from a sensing management entity, a request for assistance information (e.g., presence and/or positioning information) of one or more devices associated with an area of interest (e.g., according to indicated permissibility criteria). In one embodiment, the second method includes determining the assistance information associated with the area of interest. Note that the area of interest may be received in the request for assistance information or may be at least partially obtained based on LMF negotiations/request from the RAN. In one embodiment, the second method includes transmitting, to the sensing management entity, a response to the request for the assistance information.

In one embodiment, the assistance information comprises positioning information associated with the one or more devices.

In one embodiment, the request for the assistance information (i.e., SF request of the LMF) comprises an indication for one or more of: A) a presence of the one or more devices within the area of interest; B) positioning information associated with the one or more devices; C) velocity information associated with the one or more devices; D) a device identifier (e.g., a temporary identifier of a UE for further communication and message exchange between the SF to the UE); E) RCS information associated with the one or more devices (e.g., of a device itself or its surrounding); F) a set of KPIs for the assistance information; (e.g., accuracy/reliability of the reported device presence or device position information of device velocity information); or G) a combination thereof.

In one embodiment, the request for the assistance information (i.e., SF request of the LMF) comprises first timing information (e.g., a time point or window of time) associated with a validity period of the assistance information (e.g., the presence of a UE at an indicated time of future).

In one embodiment, the first timing information comprises one or more of: A) a future time point for an estimated presence of the one or more devices; B) a future time point for an estimated position associated with the one or more devices; C) a window of time during which to determine presence information associated with the one or more devices; D) a window of time during which to determine positioning information associated with the one or more devices; or E) a combination thereof.

In one embodiment, the request for the assistance information (i.e., SF request of the LMF) further includes second timing information indicating a reporting configuration for the assistance information.

In one embodiment, the second timing information comprises one or more of: A) a reporting start time; B) a reporting periodicity (e.g., delta); C) a reporting duration; D) a reporting end time; or E) a combination thereof.

In one embodiment, the second timing information indicates a reporting time for the assistance information, wherein the first timing information indicates a validity period at a future time later than the reporting time (e.g., the presence of the UE devices are predicated at 3 secs from the time reference, but the predicted information reported after 1 sec of the time reference).

In one embodiment, the second method includes reporting the assistance information to the sensing management entity according to the reporting configuration.

In one embodiment, the first timing information indicates a set of reporting occasions for the response to the request for the assistance information.

In one embodiment, the second method includes transmitting the response to the request for the assistance information (i.e., LMF response to SF) only when the assistance information is updated (e.g., a new device has satisfied the permissibility condition, a device information (e.g., position/velocity or RCS estimate) has been changed).

In one embodiment, the response to the request for the assistance information (i.e., LMF response to SF) comprises one or more of: A) a respective device identifier for each of the one or more devices associated with the area of interest that satisfies a set of permissibility criteria; B) respective spatial position information for each of the one or more devices associated with the area of interest that satisfies a set of permissibility criteria; C) respective velocity information for each of the one or more devices associated with the area of interest that satisfies a set of permissibility criteria; D) RCS information associated with the one or more devices; E) respective capability information for sensing measurements for each of the one or more devices associated with the area of interest; or F) a combination thereof.

In one embodiment, the response to the request for the assistance information (i.e., LMF response to SF) comprises a negative response (e.g., incapability) indicating that the assistance information is unattainable according to the request.

In one embodiment, the negative response further comprises: A) a cause value (e.g., a reason indicated via an index/value) associated with the negative response; B) a reason for the negative response (e.g., LMF may not estimate/predict a subset of the permissibility condition parameters); C) a proposed modification to the request for the assistance information; or D) a combination thereof.

In one embodiment, the negative response comprises an indication that none of the one or more devices associated with the area of interest satisfy a set of permissibility criteria.

In one embodiment, the one or more devices include at least one UE.

In one embodiment, the one or more devices include at least one RAN node.

In one embodiment, the location management entity comprises a network function (e.g., LMF), a RAN node, or a combination thereof.

In one embodiment, the location management entity is implemented as part of a core network, as part of a RAN, as a UE device, or a combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a network function, the apparatus comprising:
at least one memory; and
at least one processor coupled with the at least one memory and configured to cause the apparatus to:
receive, from a sensing services client, a request for sensing information;
transmit, to a location management entity, a request for assistance information of one or more devices associated with an area of interest;
receive, from the location management entity, a response to the request for the assistance information; and
determine the sensing information based at least in part on received assistance information.

2. The apparatus of claim 1, wherein the assistance information comprises positioning information associated with the one or more devices.

3. The apparatus of claim 1, wherein the at least one processor is configured to cause the apparatus to determine to request the assistance information from the location management entity, wherein the determination to request the assistance information is based on permissibility information comprising one or more of:
the area of interest;
a minimum device size;
a value range of a radio cross-section (RCS) information type;
a velocity margin of the one or more devices; or
a device capability for sensing measurements.

4. The apparatus of claim 1, wherein the request for the assistance information comprises an indication for one or more of:
a presence of the one or more devices within the area of interest;
positioning information associated with the one or more devices;
velocity information associated with the one or more devices;
a device identifier;
radio cross-section (RCS) information associated with the one or more devices; or
a set of Key Performance Indicators (KPIs) for the assistance information.

5. The apparatus of claim 1, wherein the request for the assistance information comprises first timing information associated with a validity period of the assistance information.

6. The apparatus of claim 5, wherein the first timing information comprises one or more of:
a future time point for an estimated presence of the one or more devices;
a future time point for an estimated position associated with the one or more devices;
a window of time during which to determine presence information associated with the one or more devices; or
a window of time during which to determine positioning information associated with the one or more devices.

7. The apparatus of claim 5, wherein the request for the assistance information further includes second timing information indicating a reporting configuration for the assistance information.

8. The apparatus of claim 7, wherein the second timing information comprises one or more of:
a reporting start time;
a reporting periodicity;
a reporting duration; or
a reporting end time.

9. The apparatus of claim 7, wherein the second timing information indicates a reporting time for the assistance information, wherein the first timing information indicates a validity period at a future time later than the reporting time.

10. The apparatus of claim 5, wherein the first timing information indicates a set of reporting occasions for the response to the request for the assistance information.

11. The apparatus of claim 1, wherein the response to the request for the assistance information comprises one or more of:
a respective device identifier for each of the one or more devices associated with the area of interest that satisfies a set of permissibility criteria;
respective spatial position information for each of the one or more devices associated with the area of interest that satisfies a set of permissibility criteria;
a presence indication of the one or more devices associated with an area of interest;
a presence probability indication of the one or more devices associated with an area of interest;
respective velocity information for each of the one or more devices associated with the area of interest that satisfies a set of permissibility criteria;
radio cross-section (RCS) information associated with the one or more devices; or
respective capability information for sensing measurements for each of the one or more devices associated with the area of interest.

12. The apparatus of claim 1, wherein the response to the request for the assistance information comprises a negative response indicating that the assistance information is unattainable according to the request.

13. The apparatus of claim 12, wherein the negative response further comprises:
a cause value;
a reason for the negative response; or
a proposed modification to the request for the assistance information.

14. The apparatus of claim 12, wherein the negative response comprises an indication that none of the one or more devices associated with the area of interest satisfy a set of permissibility criteria.

15. The apparatus of claim 1, wherein the at least one processor is configured to cause the apparatus to report the sensing information to the sensing services client.

16. The apparatus of claim 1, wherein the one or more devices include at least one user equipment (UE).

17. The apparatus of claim 1, wherein the one or more devices include at least one radio access network (RAN) node.

18. A method performed by a network function, the method comprising:
receiving, from a sensing services client, a request for sensing information;
transmitting, to a location management entity, a request for assistance information of one or more devices associated with an area of interest;
receiving, from the location management entity, a response to the request for the assistance information;
determining the sensing information based at least in part on received assistance information; and
reporting the sensing information to the sensing services client.

19. An apparatus for performing a network function, the apparatus comprising:
at least one memory; and
at least one processor coupled with the at least one memory and configured to cause the apparatus to:
receive, from a sensing management entity, a request for assistance information of one or more devices associated with an area of interest;
determines the assistance information associated with the area of interest; and
transmit, to the sensing management entity, a response to the request for the assistance information.

20. A method performed by a network function, the method comprising:
receiving, from a sensing management entity, a request for assistance information of one or more devices associated with an area of interest;
determining the assistance information associated with the area of interest; and
transmitting, to the sensing management entity, a response to the request for the assistance information.
